(19) United States
(12) Patent Application Publication
(10) Pub. No.: US 2021/0322939 A1
(43) Pub. Date: Oct. 21, 2021

(54) DYNAMIC MIXER DISPENSE VALVEFOR TWO-COMPONENT HIGH-VISCOSITY HIGH RATIO COMPOUNDS HAVING QUICK CHANGE CARTRIDGE

(71) Applicants: Bruce H. Menk, Costa Mesa, CA (US); Fabio H. Okada, Aliso Viejo, CA (US)

(72) Inventors: Bruce H. Menk, Costa Mesa, CA (US); Fabio H. Okada, Aliso Viejo, CA (US)

(21) Appl. No.: 17/249,835

(22) Filed: Mar. 15, 2021

Related U.S. Application Data
(63) Continuation-in-part of application No. 15/917,362, filed on Mar. 9, 2018, now Pat. No. 10,946,354.

(51) Int. Cl. B01F 15/02; B01F 7/00; G01F 11/28; G01F 11/34

(52) U.S. Cl. CPC B01F 15/0261; B01F 7/00341; B01F 2215/006; G01F 11/28; G01F 11/34; B01F 7/00633

(57) ABSTRACT

A dynamic mixer dispense valve and metering apparatus suitable for use in mixing and applying high viscosity, disparate viscosity, high ratio, and/or relatively immiscible two part compounds that exhibit short cure times includes a housing supporting a pair of valve assemblies each coupled to respective sources of base and accelerator components. A pair of pneumatic valve actuators control the operation of the valve assemblies to control the flow of components into a mixing chamber. Within the mixing chamber a mixer impeller is rotatably supported and coupled to a source of rotational power. An additional pneumatic valve actuator combination operates a further flow control to prevent undesired material loss following a shot cycle.Note

### CROSS-REFERENCE TO RELATED APPLICATION

This application is a Continuation-In-Part of co-pending application Ser. No. 15/917,362 entitled DYNAMIC MIXER DISPENSE VALVE FOR TWO-COMPONENT HIGH-VISCOSITY HIGH-RATIO COMPOUNDS, filed Mar. 9, 2018 in the name of Bruce H. Menk al, the disclosure which is incorporated herein by reference.

### FIELD OF THE INVENTION

This invention relates generally to two component thermosetting compounds such as adhesives and sealants and particularly to apparatus for on demand mixing, metering and dispensing such compounds.

### BACKGROUND OF THE INVENTION

In several Industries, such as aerospace manufacturing industries and the like, increased manufacturing efficiency, quality, and reliability are achieved by utilizing various thermosetting adhesive/sealants in the manufacturing process. This invention relates to a special class of (low slump) polysulfide corrosion inhibitive fuel tank sealants manufactured by companies such as PPG Aerospace and 3M Aerospace.

Two component thermosetting adhesives/sealant, often referred to generally as “thermosets”, are comprised of a base component polymer and an accelerator catalyst component. When stored separately in their respective container the base and catalyst components typically have shelf lives of six to twelve months at room temperature. When the base and catalyst are mixed together the curing or “hardening” reaction begins. As the compound cures, the viscosity gradually increases until it becomes a solid. During time period following component mixing and preceding hardening, there is a period of useful application time known as “working time”, so described because the mixed compound may be applied to the desired working surface as a viscous flowable material using any of a number of dispensers. Typical working times range from thirty minutes to two hours. For most manufacturing applications, the volume of usage makes the inefficiencies of hand mixing prohibitive due to the relatively short working time of the mixed compound. To overcome this disadvantage, dual component cartridge mixing systems or meter/mix dispensing machines are utilized. Most of these systems incorporate the use of a disposable static mixing nozzle. The advantage is that the compound is mixed and then quickly dispensed to the application shortly after mixing thereby minimizing the issue of limited working time.

Most adhesive/sealants can be meter/mix dispensed utilizing inexpensive disposable static mixing nozzles. Static mixing nozzles are relatively inexpensive and can be used to fill disposable cartridges for remote application or for direct application via robotic or handheld dispensing valves. These mixers are effective because many adhesive/sealant manufacturers formulate the compounds to have similar A/B component viscosities, close mixing ratios i.e., 1:1, 2:1, 4:1, and high miscibility (blending capability) to facilitate the mixing properties. However, not all adhesive/sealants can be formulated to incorporate all of these properties. Some compound formulations that have wide mix ratios i.e., 10:1 to 100:1, wide disparities of A/B component viscosities, and/or poor miscibility do not mix thoroughly within disposable static mixers. In some cases, this has been resolved by utilizing more expensive non-disposable static mixers or dynamic mixers. The disadvantage is that these mixers are generally not disposable and require either solvent flushing, base purging, i.e. a process in which base component alone is flushed through the mixer, or quick freezing the mixer, in which a quantity of mixed compound remains, to temporarily arrest the curing reaction and thereby preserve the mixer for later use.

Polysulfide (low slump) sealants referred to above as a class of compounds is one of the more difficult thermosets to process. The typical properties are characterized by wide viscosity disparity between base and catalyst components. For example, it is not uncommon for such adhesive and/or sealant compounds to have base components characterized by viscosities of approximately 1,600,000 cps (centipoise) with the accelerator components having viscosities of approximately 2,000 cps. In addition, such compounds typically have wide mix ratios of 10:1 base and accelerator components. In order to be metered/mixed thoroughly, such compounds are commonly processed within longer non-disposable static mixers. On demand processing for direct application with these longer mixers is not efficient due to the combined size and weight of the mix tube assembly. As a result, industries have often settled upon a processing method in which mixed compound is loaded into disposable cartridges, similar to common caulking cartridges, that are immediately quick frozen and stored at sub-freezing temperatures for future use.

One process that makes use of mixing and quick freezing of thermosets is set forth in a brochure entitled “Customized Sealant Solutions” published by PPG Aerospace and available online at www.pgaerospace.com/getdoc/47d73996-f33d-45c2-a671-3879d1904d37/PRC-P. This process is generally known in the art as “Premixed and Frozen” (PMF). This PMF is a process and service offered by PPG Aerospace and other companies for mixing and freezing sealants in disposable cartridges. The compounds are mixed, packaged in cartridges, quick-frozen and thereafter stored at approximately negative sixty degrees Fahrenheit. At such temperatures, the curing reaction is dramatically slowed permitting the cartridges to be stored for days or weeks. The main advantage of the PMF process is that when the sealant/adhesive compound is required for use, the cartridges are removed from frozen storage and thawed out for immediate application on the production line. The cartridge dispensing guns used with such cartridges are light and compact making PMF cartridges cost effective for small remote access applications on aerospace structures. However when PMF cartridges are used for large open access applications such as wing structures, the manufacturing efficiency of a small cartridge application is lost due to the large quantities required. Compared to bulk dispensing equipment utilizing robotic direct application, the manufacturing efficiency of cartridge dispensing is lost. In addition, when the associated costs of PMF packaging, storage, expired cartridge shelf life, cartridge waste disposal and intensive application labor are considered, PMF cartridges are not cost effective. Unfortunately, an automated solution as described above has been elusive due to the current state of art limitations for processing polysulfide sealants. The focus of the present invention is to provide an efficient and cost effective solution for the processing and application of such polysulfide sealants.

In related art, a dispensing valve, model 2151-482-001, manufactured by Nordson Sealant Equipment offers a dispensing valve utilizing a disposable dynamic static element mixer. It is an efficient for mixing for low viscosity difficult to mix compounds but is not a viable solution for mixing high viscosity compounds, such as polysulfide, especially at relatively high mixing flow rates.

U.S. Pat. No. 4,951,843 issued to Paetow sets forth a gun for dynamically mixing and discharging of a chemical mixture such as a sealant having a mixing chamber with a motor driven spindle mounted for rotation within the mixing chamber. A discharge outlet formed in the mixing chamber is controlled by a trigger mechanism to dispense material from the mixing chamber. The gun utilizes preloaded disposable material cartridges which support a rotatable motor driven spindle therein.

Published US patent application US 2008/0087683 filed on behalf of Wagner et al sets forth a dynamic mixer dispense valve utilized in mixing dental substances having a mixing chamber defining first and second flow paths for the constituent materials and a rotatable mixer.

U.S. Pat. No. 5,249,862 issued to Harold et al sets forth a DYNAMIC MIXER having a cylindrical chamber portion, the rear and of which is closed by a sealing plate which in turn supports pipe sockets adapted for direct insertion into outlet openings of cartridges from which pastry components to be mixed are supplied. Within the cartridge, a mixer impeller is rotatably supported to provide dynamic mixing of the pastry components.

Two component adhesive and sealant compounds bring substantial advantage to manufacturing operations and are, therefore, likely to be used ever more extensively in future manufacturing operations. There remains therefore a continuing and unresolved need in the art for an improved and more effective dynamic mixer dispense valve and metering apparatus suitable for use in mixing and applying high viscosity, disparate viscosity, high ratio, and/or relatively immiscible two part compounds that exhibit short cure times. There remains a further need for such effective dynamic mixer dispense valve apparatus which facilitates use thereof in a robotic environment and which is suitable for flexibility of application duration so as to facilitate both short shot and long path deposition of sealant and adhesive compounds while avoiding problems of unreliable interruption or termination of compound flow and the use of so-called “snuff-back apparatus attempting to reduce the long-standing and vexing problems of oozing and dribbling at shot termination.

### SUMMARY OF THE INVENTION

Accordingly, it is a general object of the present invention to provide an improved and more effective dynamic mixer dispense valve and dispensing apparatus suitable for use in mixing and applying high viscosity, disparate viscosity, high ratio, and/or relatively immiscible two part compounds that sometimes exhibit short cure times. It is a more particular object of the present invention to provide such an improved and effective dynamic mixer dispense valve and metering apparatus which facilitates use in a robotic environment and is suitable for flexibility of application duration so as to facilitate both short shot and long path deposition of such two component sealant and adhesive compounds while avoiding problems of unreliable interruption or termination of compound flow between shot cycles, for example, oozing dripping.

It is a further object of the present invention to provide an improved dispensing valve utilizing a disposable dynamic mixer dispense valve that is integrated with a disposable cartridge mixing chamber. The mixer design is effective for processing thermosets having disparate viscosities of base and catalyst components characterized by wide mix ratios such as 10 to 1 to 100 to 1 or fluids with lower miscibility. The mixer motor drive can be directly mounted on the dispense valve for fixed stationary applications or may utilize a remote drive through a flexible drive cable shaft to reduce the size and weight of the dispense valve and thereby enable robotic articulated applications. In addition, the dispense valve includes a unique feature whereby the mixer driveshaft is actuated to the mixer tip and cartridge outlet port at the termination of a dispense cycle. This prevents flow of compressed compound present within the cartridge during the dispense cycle from flowing outwardly at the termination of a dispense cycle. This capability is critical for utilization of the present invention dynamic mixer dispense valve within robotic applications which cannot tolerate post cycle flow such as oozing or dripping onto the work substrate.

It is a still further object of the present invention to provide an improved dispensing valve utilizing a disposable dynamic mixer dispense valve that is integrated with a removable and disposable cartridge mixing chamber particularly suited to robotic operation and replacement. Accordingly, the present invention further provides an improved dispensing valve utilizing a disposable dynamic mixer dispense valve that utilizes a mixer impeller cartridge having an extending drive shaft together with a drive receptacle, supported on the mixer, cooperating to facilitate a snap-fit removal and installation of the cartridge.

In accordance with the present invention, there is provided a viable method and apparatus that is a cost effective solution for continuous robotic application of polysulfide sealants which utilizes a disposable dynamic mixer as opposed to a static mixer. The difference between these mixers is that a dynamic mixer has a moving impeller and the static mixer has no moving parts. The static mixer consists of individual mixing elements stacked within a tube in a 90° orientation that divide the liquid flow in both horizontal and vertical directions to create a homogeneous fluid blend. A dynamic mixer typically consists of one or more inline paddles, blades, or impellers contained in a cylinder that spin to mix the fluid into a homogeneous liquid. They typically do a better job of mixing compared to a static mixer especially with more difficult to blend liquid compounds. Most dynamic mixers are not disposable and require cleaning for reuse such as solvent flushing. Polysulfide has poor miscibility with solvents so in this ease solvent flushing is not an option. Manual cleaning is not viable in production environment. This makes a disposable dynamic mixer the ideal solution for mixing polysulfide.

The invention further provides a dynamic mixer dispense valve for use in combination with metered supplies of a base component and an accelerator component to provide for continuous on demand dynamic mixing and dispensing of a mixed compound composed of the base component and accelerator component, said dynamic mixer dispense valve comprising: a valve manifold having first and second valve manifold portions defining respective first and second valve manifold passages; first and second valve assemblies having first and second material inputs for receiving supplies of base component and accelerator component respectively each operating in an open configuration allowing base component and accelerator component to flow into said first and second valve manifold passages respectively or a closed configuration in which flow of base component and accelerator component is prevented; first and second pneumatic valve actuators coupled to said first and second valve assemblies respectively each operating in response to a pneumatic input to configure said first and second valve assemblies into either said open configuration or said closed configuration; a cartridge manifold joined to said valve manifold and defining first and second cartridge manifold passages communicating with said first and second valve manifold passages; a cartridge retainer joined to said cartridge manifold defining a cartridge retainer interior and a cartridge discharge outlet; a cartridge coupled to said cartridge manifold and supported within said cartridge retainer interior defining an interior mixing chamber and a valve seat in communication with said cartridge discharge outlet; a mixer impeller defining a plurality of mixer blades and valve cone; an impeller drive apparatus having a rotational power coupling and an impeller drive shaft, said impeller drive shaft being rotationally supported by said valve manifold and being operatively coupled to said mixer impeller to rotate said mixer impeller within said interior or mixing chamber; and a pneumatic mixer actuating apparatus coupled to said impeller drive shaft operating in response to a pneumatic input to move said mixer impeller to either a closed position in which said valve cone is seated within said cartridge valve seat to prevent material flow through said cartridge discharge outlet or to move said mixer impeller to an open position in which said valve cone is spaced from said seat allowing material flow through said discharge outlet.

### BRIEF DESCRIPTION OF THE DRAWINGS

The features of the present invention, which are believed to be novel, are set forth with particularity in the appended claims. The invention, together with further objects and advantages thereof, may best be understood by reference to the following description taken in conjunction with the accompanying drawings, in the several figures of which like reference numerals identify like elements and in which:

FIG. 1 sets forth a perspective view of a dynamic mixer dispense valve constructed in accordance with the present invention;

FIG. 2 sets forth a front view of the present invention dynamic mixer;

FIG. 3 sets forth a rearview of the present invention dynamic mixer;

FIG. 4 sets forth a top of the present invention dynamic mixer;

FIG. 5 sets forth a side elevation view of a mixer impeller utilized in the present invention dynamic mixer;

FIG. 6 sets forth a front view of the mixer impeller, shown in FIG. 5, utilized in the present invention dynamic mixer;

FIG. 7 sets forth a section view of the present invention dynamic mixer dispense valve in its closed inoperative configuration;

FIG. 8 sets forth a section view of the present invention dynamic mixer dispense valve in its open operative configuration;

FIG. 9 sets forth a front view of an alternate embodiment of the present invention dynamic mixer dispense valve utilizing a direct drive apparatus;

FIG. 10 sets forth a front perspective view of a still further alternate embodiment dynamic mixer dispense valve constructed in accordance with the present invention;

FIG. 11 sets forth a further front perspective view of the alternate embodiment dynamic mixer dispense valve shown in FIG. 10;

FIG. 12 sets forth a front perspective view of a cartridge retainer housing supporting a cartridge having an upwardly extending drive shaft;

FIG. 13 sets forth a perspective assembly view of the alternate embodiment dynamic mixer dispense valve shown in FIG. 10;

FIG. 14 sets forth a section view of the alternate embodiment dynamic mixer dispense valve shown in FIG. 10;

FIG. 15 sets forth an enlarged section view of the lower portion of the alternate embodiment dynamic mixer dispense valve shown in FIG. 10;

FIG. 16 sets forth a front perspective view of a cartridge retainer housing receiving interchangable cartridges reach cartridge having an upwardly extending drive shaft;

FIG. 17 sets forth a perspective assembly view of an alternate embodiment of the operative components of the cartridge snap-fit interchange apparatus as utilized in the dynamic mixer dispense valve shown in FIG. 10; and

FIG. 18 sets forth a perspective view of an alternate embodiment cartridge retainer housing having a faceted sidewall and cooperating sensors for confirming assembly of the cartridge retainer to the mixer and the presence of a cartridge within the cartridge retainer housing.

### DESCRIPTION OF THE PREFERRED EMBODIMENTS OF THE INVENTION

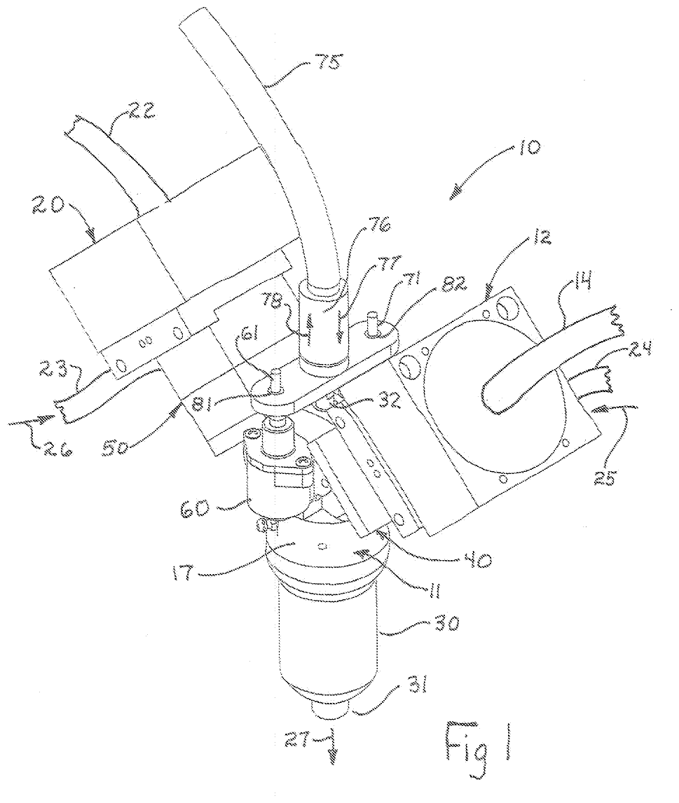

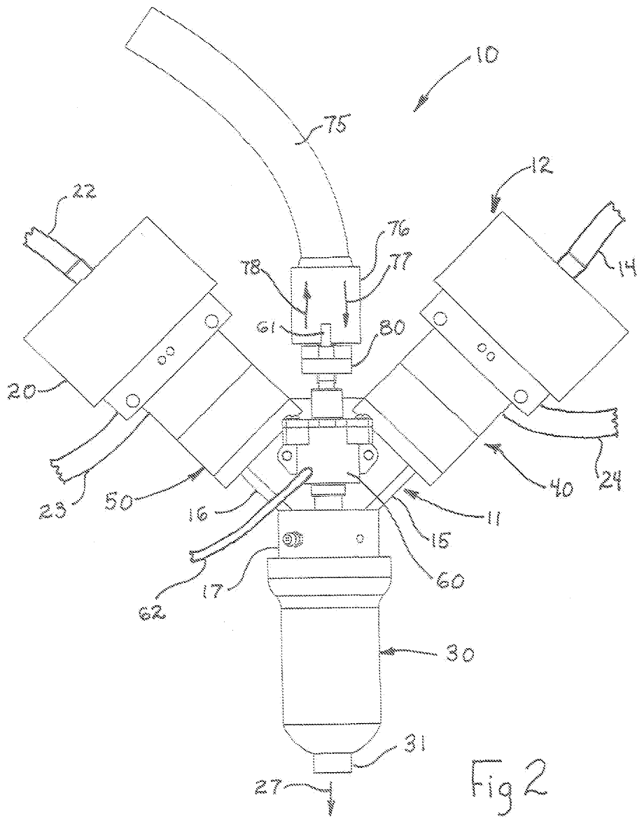

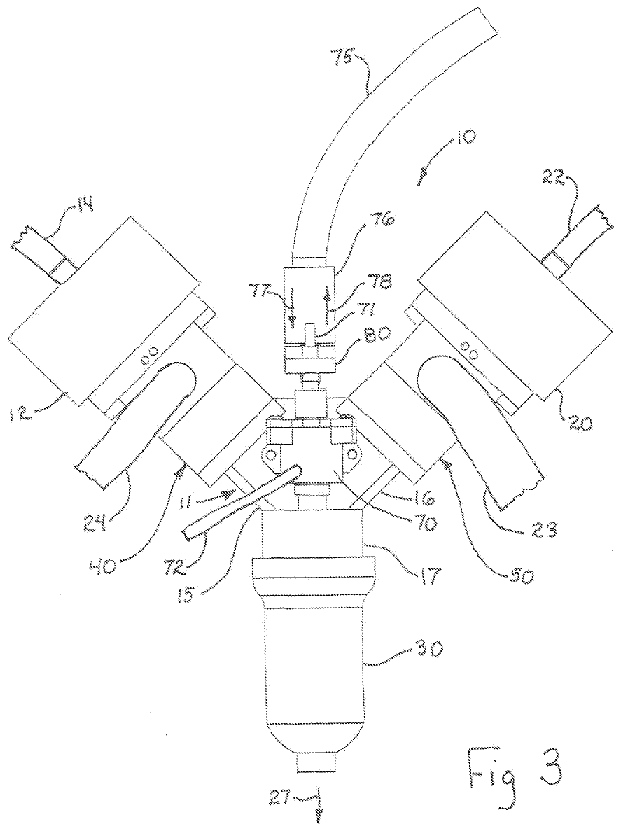

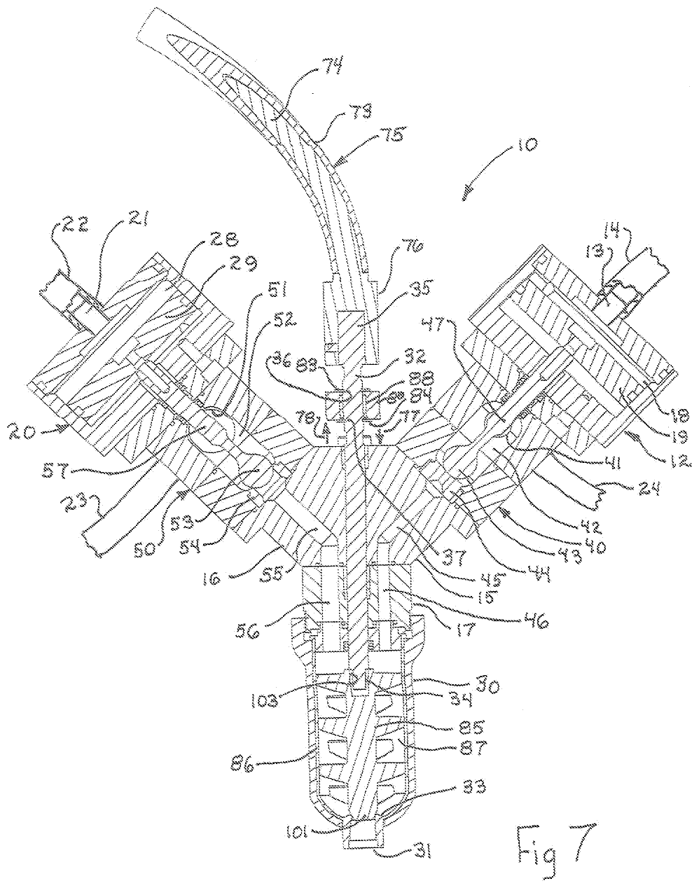

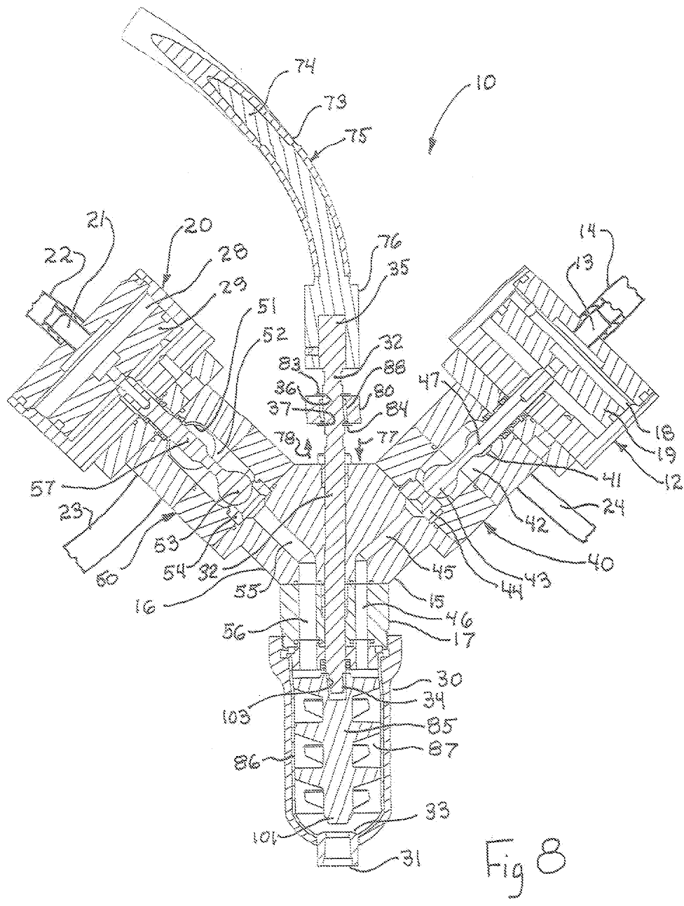

FIG. 1 sets forth a perspective view of a dynamic mixer dispense valve for two-component, high viscosity, high-ratio, disparate viscosity compounds constructed in accordance with the present invention and generally referenced by numeral 10. Dynamic mixer dispense valve 10 includes a valve manifold 11 which, as is better seen in FIG. 2, defines a generally “Y-shaped” housing having diverging upper valve manifold portions 15 and 16 supporting valve housings 40 and 50, respectively, extending outwardly at diverging angles from valve manifold 11 and a downwardly extending cartridge manifold 17 which in turn supports cartridge retainer housing 30. Cartridge retainer housing 30 is interchangeably referred to herein as “cartridge retainer” or “cartridge retainer housing” or simply “retainer housing” and is secured to cartridge manifold 17 by a conventional threaded attachment and defines a downwardly extending cartridge discharge outlet 31. In the preferred fabrication of the present invention, cartridge retainer 30 is fabricated of a high strength pressure resistant material such as steel or the like. Valve manifold 11 further supports a pair of pneumatic mixer actuators 60 and 70 (pneumatic mixer actuator 70 seen in FIG. 3) positioned on opposite faces of valve manifold 11. Pneumatic mixer actuators 60 and 70 further support a pair of upwardly extending actuator shafts 61 and 71 respectively. An elongated mixer actuator flange 80 defines a pair of apertures 81 and 82 which receive actuator shafts 61 and 71 respectively in an attachment such as threaded engagement (not shown). As is better seen in FIG. 7, mixer actuator flange 80 farther defines an aperture supporting a bearing 88. Drive cable 75 is operatively coupled to an impeller drive shaft 32 by a drive coupling 76. Drive shaft 32 is rotatably supported within valve manifold 11 and extends downwardly from drive coupling 76 through mixer a actuator flange 80. A pair of retainers 83 and 84 couple drive shaft 32 to actuator flange 80 in a rotational coupling. As is also better seen in FIG. 7, drive cable 75 and drive coupling 76 comprise impeller drive apparatus which couple rotational power from a convention rotational power source (not shown) to impeller drive shaft 32. Impeller drive shaft 32 is, in turn, coupled to a mixer impeller 85 for rotation within a mixer cartridge 86.

Valve assembly 40 extending upwardly and outwardly from valve manifold 11 further supports a pneumatic valve actuator 12. Similarly, valve assembly 50 extends upwardly and outwardly from valve manifold 11 and further supports a pneumatic valve actuator 20. Pneumatic valve actuator 12 is further coupled to a pneumatic control line 14 while pneumatic valve actuator 20 is further coupled to a pneumatic control line 22. Pneumatic control lines 14 and 22 are coupled to a pneumatic controller (not shown) which may be constructed in accordance with conventional pneumatic control fabrication techniques. Valve assembly 40 is coupled to a supply of accelerator component through an accelerator supply line 24. Similarly, valve assembly 50 is coupled to a supply of base component through a base supply line 23. Accelerator supply line 24 and base supply line 23 are coupled to pressurized supplies of accelerator and base components provided by pumping apparatus (not shown). While a variety of pumping apparatus may be utilized in combination with the present invention dynamic mixer dispense valve without departing from the spirit and scope of the present invention, it has been found particularly advantageous to utilize pumping apparatus manufactured by Fluidic Systems, Inc. that includes variable mix ratio and continuous metered flow capability, which are sold under the model number PK2D.

By way of overview, the operation of dynamic mixer dispense valve 10 is carried forward as dynamic mixer dispense valve 10 is supported within the desired operative environment by either a robotically operated apparatus or a manually operated apparatus (not shown) either of which may be fabricated in accordance with conventional fabrication techniques. Within the operative environment of dynamic mixer dispense valve 10, a supply of base component under pressure is provided through base supply line 23 which flows in the direction indicated by arrow 26 through valve manifold 11 under the control of valve apparatus (seen in FIG. 7) within valve assembly 50. Similarly, a supply of accelerator component is provided through accelerator supply line 24 which flows in the direction indicated by arrow 25 through valve manifold 11 under the control of valve apparatus (seen in FIG. 7) within valve assembly 40. As mentioned, the valve apparatus within valve housings 40 and 50 are set forth below in FIG. 7 in greater detail. Suffice it to note here that the valve apparatus are operative under the control of pneumatic valve actuators 12 and 20 respectively. It will be further recognized that the operations of pneumatic valve actuators 12 and 20 are, in turn, controlled by the air pressures applied through pneumatic control lines 14 and 22 respectively.

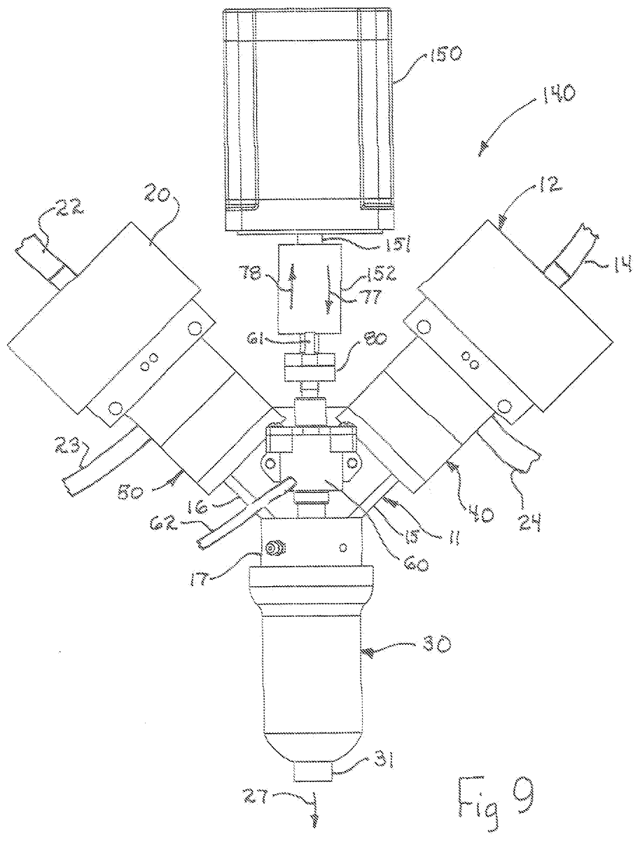

The individual flows of the base and accelerator components are directed by passages within valve manifold 11 (seen in FIG. 7) into the interior of mixer cartridge 86. A mixer impeller 85 (also seen in FIG. 7) is rotationally driven to mix the individual flows of base and accelerator components into a mixture compound which is dispensed outwardly in the direction indicated by arrow 27 through a cartridge discharge outlet 31 formed at the bottom end of mixer cartridge 86. Because the flows of base and accelerator components are controlled by pneumatic valve actuators 12 and 20, the resulting flow of mixed compound dispensed through cartridge discharge outlet 31 is also controlled by pneumatic valve actuators 12 and 20. It should noted that the mixed base and accelerator compound is a compressible compound. As a result, the flow of base and accelerator components into mixer cartridge 86 is a flow of a compressible compound under pressure which compresses the mixture creates a residual pressure within mixer cartridge 86 which, if left uncontrolled, could cause the above mentioned oozing or dribbling continuation of flow from cartridge discharge outlet 31 after the valve apparatus within valve housings 40 and 50 have closed. In accordance with an important aspect of the present invention which is described below in FIGS. 7 and 8 in greater detail, the flow of mixed compound through cartridge discharge outlet 31 is further controlled by a discharge valve mechanism operative directly upon cartridge discharge outlet 31. The nature of the discharge valve mechanism is set forth in FIGS. 7 and 8 in greater detail. However, suffice it to note here, that pneumatic mixer actuators 60 and 70 (pneumatic mixer actuator 70 seen in FIG. 3) are double acting actuators operative to raisemixer impeller 85 (seen in FIG. 7) in the direction indicated by arrow 78 to allow mixed compound flow from cartridge discharge outlet 31 and to lower mixer impeller 85 in the direction indicated by arrow 77 to prevent mixed compound flow thereby providing a discharge valve mechanism. It will be apparent to those skilled in the art that actuators 60 and 70 may, alternatively be single acting actuators combined with a return spring without departing from the spirit and scope of the present invention. The provision of this discharge valve mechanism produces a direct positive control of material flow from cartridge discharge outlet 31 in order to prevent the above described problems of material “oozing” and “dribbling” at shot cycle termination.

Accordingly, dynamic mixer dispense valve 10 is positioned for controlled dispensing of mixed adhesive and sealant compounds by properly positioning cartridge discharge outlet 31 with respect to the manufacturing work piece and thereafter operating pneumatic valve actuators 12 and 20 to provide flows of base and accelerator components into cartridge retainer 30. Simultaneously, mixer impeller 85 (seen in FIG. 7) is rotated to mix the base and accelerator components. As the base and accelerator components are allowed to flow downwardly into mixer cartridge 86 and are mixed by mixer impeller 85, pneumatic mixer actuators 60 and 70 (pneumatic mixeractuator 70 seen in FIG. 3) are activated to lift mixer actuator flange 80 and allow mixed compound to be dispensed downwardly through cartridge discharge outlet 31 in the direction indicated by arrow 27. The flow of mixed compound is terminated at the completion of each shot cycle by closing the valve apparatus within valve housings 40 and 50 and, using pneumatic mixer actuators 60 and 70, lowering mixer actuator flange 80 to provide positive closure of the discharge valve operative upon cartridge discharge outlet 31. This sequence of operations is carried forward to implement each shot cycle and to terminate mixed compound flow between shot cycles thereby allowing dynamic mixer dispense valve 10 to be moved across the work piece without oozing or dripping.

The operation of dynamic mixer dispense valve 10 is illustrated and described below in greater detail. However, the foregoing overview of operation will serve to illustrate a substantial number of the advantageous and inventive features of the present invention dynamic mixer dispense valve. For example, dynamic mixer dispense valve 10 provides an improved and more effective dynamic mixer and metering apparatus suitable for use in mixing and applying high viscosity, disparate viscosity, high ratio, and/or relatively immiscible two part compounds that exhibit short cure times. It should also be apparent that the present invention dynamic mixer dispense valve provides an improved and effective dynamic mixer dispense valve and metering apparatus which facilitates use in a robotic environment and is suitable for flexibility of application duration so as to facilitate both short shot and long path deposition of such two component sealant and adhesive compounds. The inventive dynamic mixer dispense valve avoids problems of unreliable interruption or termination of compound flow between shot cycles by providing a direct positive valve apparatus operative upon the material flow discharge outlet. In further accordance with an additional advantage of the present invention dynamic mixer, described below, a mixer impeller operative within mixer cartridge 86 provides an optimized turbulent flow pattern for the full and complete mixing of the difficult relatively immiscible base and accelerator components. The entire drive apparatus utilized in providing rotation of the mixer impeller is constructed to operate reliably and efficiently in mixing high viscosity, high ratio, disparate viscosity compounds.

FIG. 2 sets forth a front view of dynamic mixer dispense valve 10 in a typical operating environment in which a supply of base and accelerator components under pressure are provided together with pneumatic air control lines. A conventional flexible drive cable capable of providing rotational power is also operatively coupled to dynamic mixer dispense valve 10.

More specifically, dynamic mixer dispense valve 10 includes a generally “Y-shaped” valve manifold 11 having a pair of valve manifold portions 15 and 16 which extend upwardly and outwardly together with a downwardly extending cartridge manifold 17. Valve manifold portion 15 supports a valve assembly 40 which in turn supports a pneumatic valve actuator 12. Similarly, valve manifold portion 16 supports a valve assembly 50 which in turn supports a pneumatic valve actuator 20. Valve manifold 11 further supports a pair of pneumatic mixer actuators 60 and 70 (pneumatic mixer actuator 70 seen in FIG. 3) which in turn support and are engagingly coupled to transversely extending elongated mixer actuator flange 80. Pneumatic mixer actuators 60 and 70 are double acting actuators and define respective actuator shafts 61 and 71 (shaft 71 seen in FIG. 3) which are received within apertures 81 and 82 defined in mixer actuator flange 80. A pneumatic control line 62 is coupled to pneumatic mixeractuator 60 while a pneumatic control line 72 is coupled to pneumatic valve actuator 70 (seen in FIG. 3). A drive cable 75 includes a drive coupling 76 which is secured to end 35 of impeller drive shaft 32 in a conventional attachment. A pair of pneumatic control lines 14 and 22 are coupled to pneumatic valve actuators 12 and 20 respectively. A supply of base component under pressure is coupled to valve assembly 50 by a base supply line 23. A supply of accelerator component is coupled to valve assembly 40 by an accelerator supply line 24. Cartridge manifold 17 further supports cartridge retainer 30 in a threaded attachment which is better seen in FIG. 7. Mixer cartridge 86 defines a cartridge discharge outlet 31 extending downwardly through an aperture in the bottom of cartridge retainer 30.

FIG. 3 sets forth a rear view of dynamic mixer dispense valve 10 in the typical operating environment described above in which a supply of base and accelerator components under pressure are provided together with pneumatic air control lines. A conventional flexible drive cable capable of providing rotational power is also operatively coupled to dynamic mixer dispense valve 10.

As is also described above, dynamic mixer dispense valve 10 includes a generally “Y-shaped” valve manifold 11 having a pair of valve manifold portions 15 and 16 which extend upwardly and outwardly together with a downwardly extending cartridge manifold 17. Valve manifold portion 15 supports a valve assembly 40 which in turn supports a pneumatic valve actuator 12. Similarly, valve manifold portion 16 supports a valve assembly 50 which in turn supports a pneumatic valve actuator 20. Valve manifold 11 further supports a pair of pneumatic mixer actuators 60 and 70 (pneumatic mixer actuator 60 seen in FIG. 2) which in turn support and are operatively coupled to transversely extending elongated mixer actuator flange 80. Pneumatic mixer actuators 60 and 70 define respective actuator shafts 61 and 71 (shaft 61 seen in FIG. 2) which are received within apertures 81 and 82 defined in mixer actuator flange 80. A pneumatic control line 72 is coupled to pneumatic valve actuator 70 while a pneumatic control line 62 is coupled to pneumatic mixer actuator 60 (seen in FIG. 2). A drive cable 75 includes a drive coupling 76 which is secured to end 35 of impeller drive shaft 32 (seen in FIG. 7) in a conventional attachment. A pair of pneumatic control lines 14 and 22 are coupled to pneumatic valve actuators 12 and 20 respectively. A supply of base component under pressure is coupled to valve assembly 50 by a base supply line 23. A supply of accelerator component is coupled to valve assembly 40 by an accelerator supply line 24. Cartridge manifold 17 further supports cartridge retainer 30 in a threaded attachment which is better seen in FIG. 7. Mixer cartridge 86 defines a cartridge discharge outlet 31 extending downwardly through an aperture in the bottom of cartridge retainer 30.

With concurrent reference to FIGS. 2 and 3, dynamic mixer dispense valve 10 is operative to dispense mixed compound as base component, under pressure, is supplied through supply line 23 to valve assembly 50 and accelerator component is supplied, under pressure, to valve assembly 40 through supply line 24. Concurrently, rotational power is applied to mixer impeller 85 (seen in FIG. 7) through drive cable 75 and drive coupling 76. Appropriate air pressure signals are applied to pneumatic valve actuators 12 and 20 through pneumatic control lines 14 and 22 respectively to open the valve structures within valve housings 40 and 50 to their open configurations shown in FIG. 8. Finally, appropriate pneumatic control pressures are applied to pneumatic mixer actuators 60 and 70 through pneumatic control lines 62 and 72 respectively to lift mixer actuator flange 80 and open the discharge valve at cartridge discharge outlet 31. Thereafter, base component and accelerator component flow continuously through base supply line 23 and accelerator supply line 24 through valve housings 50 and 40 respectively into cartridge manifold 17 of valve manifold 11. The two component flows are combined within mixer cartridge 86 and mixed as mixer impeller 85 (seen in FIG. 7) is rotated by drive cable 75. With mixer actuator flange 80 raised by pneumatic mixer actuators 60 and 70 in the direction indicated by arrow 78, mixed compound flows under pressure through cartridge discharge outlet 31.

The operative shot cycle for dynamic mixer dispense valve 10 is interrupted or terminated by applying appropriate pneumatic control signals to pneumatic control lines 14 and 22 which in turn close the valve structures within valve assemblies 40 and 50 respectively. These valve closures terminate the flow of base component through valve assembly 50 and accelerator component through valve assembly 40. The interruption of flow of base component and accelerator component terminates the shot cycle. However, to prevent the above described oozing or dribbling of mixed components from mixer cartridge 86 due to residual pressure therein, pneumatic mixer actuators 60 and 70 are activated to move mixer actuator flange 80 downwardly in the direction indicated by arrow 77 to provide direct positive closure of cartridge discharge outlet 31 in the manner described below. This discharge outlet closure prevents any undesired material flow following the termination of a shot cycle.

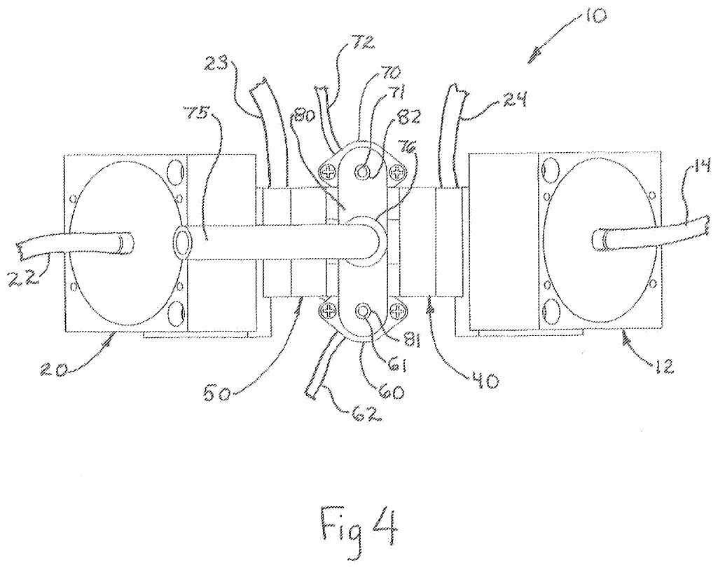

FIG. 4 sets forth a top view of dynamic mixer dispense valve 10. As described above dynamic mixer dispense valve 10 supports pneumatic valve actuators 12 and 20 each coupled to respective pneumatic control lines 14 and 22. Dynamic mixer dispense valve 10 further includes valve housings 40 and 50 supporting pneumatic valve actuators 12 and 20 respectively. Base component supply line 23 is coupled to valve assembly 50 in the manner shown in FIG. 3. Base component supply line 23 will be understood to be coupled to a supply of base component under pressure (not shown) which may be fabricated using conventional design. Similarly, accelerator component supply line 24 will be understood to be coupled to a supply of accelerator component under pressure (not shown) which may be fabricated using conventional design. Pneumatic mixer actuators 60 and 70 are supported upon the front and rear faces of dynamic mixer dispense valve 10 and are coupled to pneumatic control lines 62 and 72 respectively. Pneumatic mixer actuators 60 and 70 include respective actuator shafts 61 and 71 extending upwardly there from. Transversely extending mixer actuator flange 80 defines apertures 81 and 82 which receive actuator shafts 61 and 71 respectively in a threaded engagement.

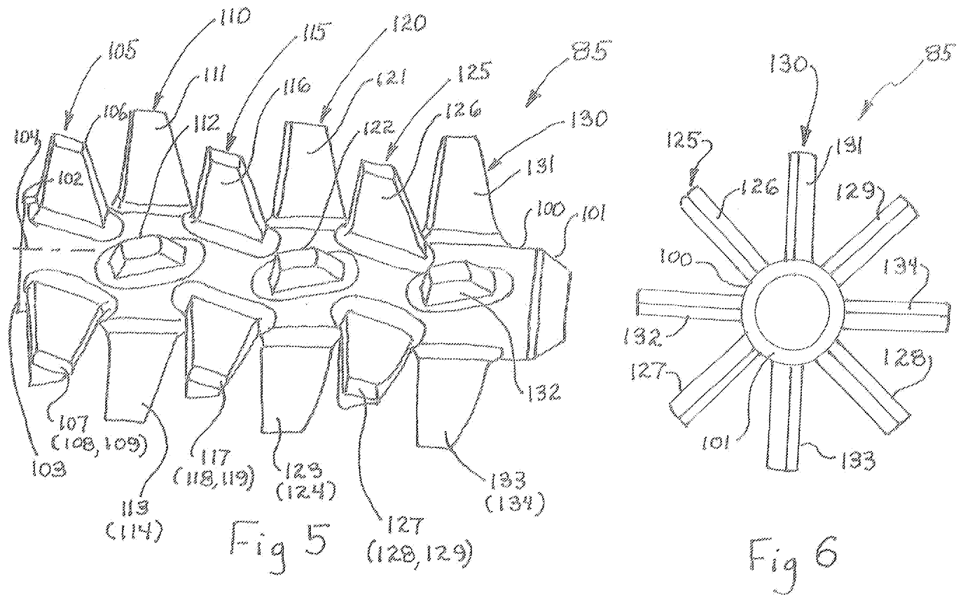

FIG. 5 sets forth a side elevation view of mixer impeller 85 which, by way of overview, includes a generally cylindrical impeller shaft 100, defining a valve cone end 101 and a drive end 102. Impeller shaft 100 supports a plurality of impeller blades. Mixer impeller 85 is preferably fabricated as an integral one piece injection molded component having a female threaded insert 103 molded into drive end 102. The plurality of impeller blades are radially disposed on impeller shaft 100 and extend radially outwardly from impeller shaft 100. The plurality of impeller blades are arranged in six mixing impeller stages, each mixing impeller stage having four evenly distributed radially extending impeller blades. In the preferred fabrication of the present invention, the impeller blades within alternate mixing impeller stages are angularly offset from the impeller blades of their respective adjacent mixing impeller stages by a forty five degree angle. In addition, the impeller blades of each mixing impeller stage are pitched (slanted) at pre-determined angles relative to the impeller shaft centerline with the impeller blades of alternate mixing impeller stages being pitched (slanted) upwardly and downwardly at opposite angles. As a result, mixer impeller 85 creates both foreword and rearward compound thrust and increased turbulence as it is rotated during the compound mixing process.

More specifically, mixer impeller 85 includes an elongated cylindrical shaft 100 having a valve cone end 101 and a drive end 102. A threaded insert 103 is molded into drive end 102 of shaft 100 during the shaft injection molding process. The function of threaded insert 103 is to receive the threaded end of impeller driveshaft 32 (seen in FIG. 7) in order to provide rotation of mixer impeller 85. Valve cone end 101 provides a valve stopper operative upon cartridge discharge outlet 31 (seen in FIG. 7) of mixer cartridge 86 (also seen in FIG. 7). As mentioned above, mixer impeller 85 supports a plurality of impeller blades arranged in mixing impeller stages 105, 110, 115, 120, 125 and 130. Each mixing impeller stage includes four impeller blades. Thus, mixing impeller stage 105 includes impeller lades 106, 107, 108 and 109 (impeller blades 108 and 109 not seen). Similarly, mixing impeller stage 110 includes impeller blades 111, 112, 113 and 114 (impeller blade 114 not shown). Mixing impeller stage 115 includes impeller blades 116, 117, 118 and 119 (impeller blade 119 not shown). Mixing impeller stage 120 includes impeller blades 121, 122, 123 and 124 (impeller blade 124 not shown). Mixing impeller stage 125 includes impeller blades 126, 127, 128 and 129 (impeller blades 128 and 129 seen in FIG. 6). Mixing impeller stage 130 includes impeller blades 131, 132, 133 and 134 (impeller blade 134 seen in FIG. 6). It will be noted that impeller blades 106, 116 and 126 of mixing impeller stages 105, 115 and 125 are pitched (slanted) downwardly relative to centerline 104 of impeller shaft 100. It will be understood that each of the remaining impeller blades within mixing impeller stages 105, 115 and 125 are also pitched (slanted) downwardly relative to centerline 104 of impeller shaft 100. Conversely, it also be noted that impeller blades 112, 122 and 132 of mixing impeller stages 110, 120 and 130 are pitched (slanted) upwardly relative to centerline 104 of impeller shaft 100. It will also be understood that each of the remaining impeller blades within mixing impeller stages 110, 120 and 130 are also pitched (slanted) upwardly relative to centerline 104 of impeller shaft 100.

FIG. 6 sets forth an end view of mixer impeller 85. Of importance to note in FIG. 6 is the angular offset between the impeller blades of alternate mixer stages described above. Specifically, FIG. 6 facilitates the illustration of the pitch angles for impeller blades of adjacent mixing impeller stages and the above-mentioned forty five degree angular offset therebetween. More specifically mixer impeller 85 includes an impeller shaft 100 supporting a valve cone 101. Mixer impeller 85 further includes a mixing impeller stage 130 having radially extending impeller blades 131, 132, 133 and 134. Mixer impeller 85 further includes a mixing impeller stage 125 having radially extending impeller blades 126, 127, 128 and 129. As can be seen, impeller blades 126, 127, 128 and 129 of mixing impeller stage 125 are offset from impeller blades 131, 132, 133 and 134 mixing impeller stage 130 by the above mentioned forty five degrees. FIG. 6 also shows the opposite pitch of impeller blades 126, 127, 128 and 129 from impeller blades 131, 132, 133 and 134. It will be understood that the identical relationships shown in FIG. 6 existing between mixing impeller stages 125 and 130 also exist between mixing impeller stages 115 and 120 as well as between mixing impeller stages 105 and 110. As is better seen in FIG. 7, the length of the impeller blades of mixer impeller 85 is sized to provide a “net fit” within mixer cartridge 86 to and sure that the impeller blades perform a wiping action upon the interior surface of mixer cartridge 86 during rotation.

By way of overview, FIGS. 7 and 8 set forth section view's of dynamic mixer dispense valve 10 prior to and during compound dispensing operations respectively. That is to say, FIG. 7 shows a section view dynamic mixer dispense valve 10 during a non-operation configuration in which the components of the to be mixed adhesive or sealant are not being mixed and dispensed. Conversely, FIG. 8 shows the same section view as FIG. 7 with the difference being found in its illustration of the dispensing configuration of dynamic mixer dispense valve 10.

Thus, as mentioned above, FIG. 7 sets forth a section view of dynamic mixer dispense valve 10 in a non-dispensing configuration in which the valves controlling the flows of base and accelerator components as well as the valve operative upon the discharge outlet are all closed. More specifically, dynamic mixer dispense valve 10 includes a valve manifold 11 having angled valve manifold portions 15 and 16 together with a downwardly extending cartridge manifold 17 forming a generally “Y-shaped” housing. Valve manifold portion 15 defines a fluid passage 45 which communicates with a fluid passage 46 formed in cartridge manifold 17. Similarly, valve manifold portion 16 defines a fluid passage 55 which communicates with a fluid passage 56 formed in cartridge manifold 17. Valve manifold portion 15 further supports a valve assembly 40 which, in turn, supports a pneumatic valve actuator 12. Valve assembly 40 defines a valve port 41 which is coupled to an accelerator supply line 24 and a valve chamber 42 in communication with port 41. Valve assembly 40 further supports a valve seat 44 at the lower end of valve chamber 42 which defines a passage extending between valve chamber 42 and passage 45. Valve assembly 40 further supports an elongated valve rod 47 having a valve ball end 43 formed on the interior end thereof. Pneumatic valve actuator 12 includes an air fitting 13 coupled to pneumatic control line 14. Pneumatic valve actuator 12 further defines a cylinder 18 within which piston 19 is movably supported by the upper end of valve rod 47.

Valve manifold portion 16 further supports a valve assembly 50 which, in turn, supports a pneumatic valve actuator 20. Valve assembly 50 defines a valve port 51 which is coupled to a base supply line 23 and a valve chamber 52 in communication with port 51. Valve assembly 50 further supports a valve seat 54 at the lower end of valve chamber 52 which defines a passage extending between valve chamber 52 and passage 55. Valve assembly 50 further supports an elongated valve rod 57 having a valve ball end 53 formed on the interior end thereof. Pneumatic valve actuator 20 includes an air fitting 21 coupled to pneumatic control line 22. Pneumatic valve actuator 20 further defines a cylinder 28 within which a piston 29 is movably supported by the upper end of valve rod 57.

Cartridge retainer 30 defines a cartridge retainer interior and is secured by threaded engagement to the lower end of cartridge manifold 17. A disposable mixer cartridge 86 is received within cartridge retainer interior of cartridge retainer 30 and defines interior mixing chamber 87 which is in fluid communication with passages 46 and 56 of cartridge manifold 17. Cartridge 86 is preferably formed in accordance with conventional fabrication techniques and is intended to be disposable. A valve seat 33 is supported at the lower end of mixer cartridge 86 and cartridge retainer 30. Valve seat 33 defines a cartridge discharge outlet 31.

Mixer impeller 85, described above in FIGS. 5 and 6, is received within interior chamber 87. As is also described above, mixer impeller 85 defines a valve cone 101 at the lower end thereof which is received within valve seat 33 and a threaded insert 103 at its drive end 102. An elongated impeller drive shaft 32 defines a threaded end 34 which is received within threaded insert 103. Impeller drive shaft 32 extends upwardly through valve manifold 11 and passes through a bearing 88 supported within mixer actuator flange 80. Impeller drive shaft 32 defines grooves 36 and 37 above and below mixer actuator flange 80 respectively which receive retainers 83 and 84 respectively to secure impeller drive shaft 32 to mixer actuator flange 80 in a rotational attachment. Impeller drive shaft 32 terminates in an upper end 35. Upper end 35 of impeller drive shaft 32 is joined to a drive coupling 76 by conventional attachment. Drive cable 75 extends from drive coupling 76 and includes an outer sleeve 73 supporting a rotatable cable shaft 74. Drive cable 75 and drive coupling 76 are fabricated in accordance with conventional fabrication techniques such that rotational power applied to cable shaft 74 by a rotational power source (not shown) produces corresponding rotation of impeller drive shaft 32 within valve manifold 11.

In operation, supplies of base component and accelerator component are pumped under pressure through base supply line 23 and accelerator supply line 24 two valve housings 50 and 40 respectively. The base component provided by base supply line 23 flows into valve chamber 52 of valve assembly 50 through port 51 causing valve chamber 52 to be filled with base material. In the closed configuration shown in FIG. 7 a pneumatic signal coupled to pneumatic valve actuator 20 by pneumatic control line 22 provides air pressure within cylinder 28 moving piston 29 and rod 57 downwardly thereby forcing valve ball 53 against valve seat 54. In this position base material is unable to flow from valve chamber 52. Similarly, the accelerator component provided by accelerator supply line 24 flows into valve chamber 42 of valve assembly 40 through port 41 causing valve chamber 42 to be filled with accelerator material. In the closed configuration shown in FIG. 7 a pneumatic signal coupled to pneumatic valve actuator 12 by pneumatic control line 14 provides air pressure within cylinder 18 moving piston 19 and rod 47 downwardly thereby forcing valve ball 43 against valve seat 44. In this position accelerator material is unable to flow from valve chamber 42.

In accordance with an important advantage of the present invention dynamic mixer, the closed conditions of the valve mechanisms within valve housings 40 and 50 which characterize the non-dispensing condition of dynamic mixer dispense valve 10, are further enhanced by a direct positive closure of cartridge discharge outlet 31. This direct positive closure is provided by the pneumatic signals which are applied to pneumatic mixer actuators 60 and 70 through pneumatic control lines 62 and 72 respectively (seen in FIGS. 2 and 3). Returning to FIG. 7, the force provided by pneumatic mixer actuators 60 and 70 pulls mixer actuator flange 80 downwardly in the direction indicated by arrow 76. The downward movement of mixer actuator flange 80 carries impeller drive shaft 32 downwardly forcing mixer impeller 85 downwardly within cartridge chamber 87 such that valve cone 101 of mixer impeller 85 is forced against valve seat 33. The pressure of valve cone 101 against valve seat 33 provides complete closure of cartridge discharge outlet 31. Importantly, the direct cartridge discharge outlet closure apparatus thus provided prevents the above described oozing and dribbling of mixed compound residing within cartridge chamber 87 which plagues prior art devices.

FIG. 8 sets forth a section view of dynamic mixer dispense valve 10 in a dispensing configuration in which the valves controlling the flows of base and accelerator components as well as the valve operative upon the discharge outlet are all in open conditions. This dispensing configuration of dynamic mixer dispense valve 10 is achieved by a pneumatic signal coupled to pneumatic valve actuator 20 by pneumatic control line 22 which decreases the air pressure within cylinder 28 moving piston 29 and rod 57 upwardly thereby moving valve ball 53 away from valve seat 54. In this position base material is able to flow from valve chamber 52 into cartridge chamber 87 through passages 55 and 56. Similarly, a pneumatic signal coupled to pneumatic valve actuator 12 by pneumatic control line 14 decreases air pressure within cylinder 18 moving piston 19 and rod 47 upwardly thereby moving valve ball 43 away front valve seat 44. In this position accelerator material is able to flow from valve chamber 42 into cartridge chamber 87 through passages 45 and 46. Finally, the configuration to the dispensing condition of dynamic mixer dispense valve 10 shown in FIG. 8 is completed by pneumatic signals applied to pneumatic mixer actuators 60 and 70 through pneumatic control lines 62 and 72 respectively (seen in FIGS. 2 and 3). The force provided by pneumatic mixer actuators 60 and 70 forces mixer actuator flange 80 upwardly in the direction indicated by arrow 78. The upward movement of mixer actuator flange 80 carries impeller drive shaft 32 upwardly moving mixer impeller 85 upwardly within cartridge chamber 87 such that valve cone 101 of mixer impeller 85 is moved away from valve seat 33. Once the valves within valve housings 40 and 50 together with the closure of cartridge discharge outlet 31 by mixer impeller 85 have been opened, the source of rotational power (not shown) coupled to drive cable 75 is activated to produce rotation of mixer impeller 85. The introduction of base and accelerator components into interior 87 of mixer cartridge 86 constitutes a fluid flow under pressure which would exceed the safe operating pressure of mixer cartridge 86. This pressure is contained by the additional strength provided by cartridge retainer 30 and ensures the safe operation of dynamic mixer dispense valve 10.

By concurrent reference to FIGS. 7 and 8 it will be apparent that the present invention dynamic mixer dispense valve is able to transition repeatedly between non-dispensing and dispensing conditions to provide a continuing number of shot cycles during manufacturing use of the dynamic mixer. The direct positive control of flow from cartridge discharge outlet 31 provided in the above described manner allows the dynamic mixer dispense valve to be freely and reliably move between shot cycles across the work piece without fear of undesired discharge or contamination of the work piece. The use of pressurized supplies of base and accelerator components on a continuous basis together with the operation of the novel mixer impeller operative within the mixer cartridge allows virtually endless continuous operation of the dynamic mixer. This in turn substantially improves the manufacturing efficiency and avoids the above described sources of difficulty and waste associated with prior art systems.

In accordance with an important advantage of the present invention dynamic mixer, the closed conditions of the valve mechanisms within valve housings 40 and 50 which characterize the non-dispensing condition of dynamic mixer dispense valve 10, are further enhanced by a direct positive closure of cartridge discharge outlet 31. This direct positive closure is provided by the pneumatic signals which are applied to pneumatic mixer actuators 60 and 70 through pneumatic control lines 62 and 72 respectively (seen in FIGS. 2 and 3). Returning to FIG. 7, the force provided by pneumatic mixer actuators 60 and 70 pulls mixer actuator flange 80 downwardly in the direction indicated by arrow 76. The downward movement of mixer actuator flange 80 carries impeller drive shaft 32 downwardly forcing mixer impeller 85 downwardly within cartridge chamber 87 such that valve cone 101 of mixer impeller 85 is forced against valve seat 33. The pressure of valve cone 101 against valve seat 33 provides complete closure of cartridge discharge outlet 31. Thus, the combination of pneumatic mixer actuators 60 and 70 each acting upon mixer actuator flange 80 and drive coupling 76 combined to form a pneumatic mixer actuating apparatus which operates to move mixer impeller 85 and particularly valve cone 101 with respect to valve seat 33 two provide direct positive closure of cartridge discharge outlet 31 at the termination of a shot cycle. As mentioned above, this direct positive closure avoids the problems of oozing and dribbling of the pressurized compound within the interior mixing chamber at the termination of a shot cycle.

More specifically and as is described above, dynamic mixer dispense valve 10 includes a valve manifold 11 having angled valve manifold portions 15 and 16 together with a downwardly extending cartridge manifold 17 forming a generally “Y-shaped” housing. Valve manifold portion 15 defines a fluid passage 45 which communicates with a fluid passage 46 formed in cartridge manifold 17. Similarly, valve manifold portion 16 defines a fluid passage 55 which communicates with a fluid passage 56 formed in cartridge manifold 17. Valve manifold portion 15 further supports a valve assembly 40 which, in turn, supports a pneumatic valve actuator 12. Valve assembly 40 defines a valve port 41 which is coupled to an accelerator supply line 24 and a valve chamber 42 in communication with port 41. Valve assembly 40 further supports a valve seat 44 at the lower end of valve chamber 42 which defines a passage extending between valve chamber 42 and passage 45. Valve assembly 40 further supports an elongated valve rod 47 having a valve ball end 43 formed on the interior end thereof. Pneumatic valve actuator 12 includes an air fitting 13 coupled to pneumatic control line 14. Pneumatic valve actuator 12 further defines a cylinder 18 within which a piston 19 is movably supported by the upper end of valve rod 47.

As is also described above, valve manifold portion 16 further supports a valve assembly 50 which, in turn, supports a pneumatic valve actuator 20. Valve assembly 50 defines a valve port 51 which is coupled to a base supply line 23 and a valve chamber 52 in communication with port 51. Valve assembly 50 further supports a valve scat 54 at the lower end of valve chamber 52 which defines a passage extending between valve chamber 52 and passage 55. Valve assembly 50 further supports an elongated valve rod 57 having a valve ball end 53 formed on the interior end thereof. Pneumatic valve actuator 20 includes an air fitting 21 coupled to pneumatic control line 22. Pneumatic valve actuator 20 further defines a cylinder 28 within which a piston 29 is movably supported by the upper end of valve rod 57.

Cartridge retainer 30 is secured by threaded engagement to the lower end of cartridge manifold 17. A disposable mixer cartridge 86 is received within cartridge retainer 30 and defines an interior mixing chamber 87 which is in fluid communication with passages 46 and 56 of cartridge manifold 17. Cartridge 86 is preferably formed in accordance with conventional fabrication techniques and is intended to be disposable. A valve seat 33 is supported at the lower end of mixer cartridge 86 and cartridge retainer 30. Valve seat 33 defines a cartridge discharge outlet 31.

Mixer impeller 85, described above in FIGS. 5 and 6, is received within interior chamber 87. As is also described above, mixer impeller 85 defines a valve cone 101 at the lower end thereof which is received within valve seat 33 and a threaded insert 103 at its drive end 102. An elongated impeller drive shaft 32 defines a threaded end 34 which is received within threaded insert 103. Impeller drive shaft 32 extends upwardly through valve manifold 11 and passes through a bearing 88 supported within mixer actuator flange 80 and terminates in an upper end 35. Upper end 35 of impeller drive shaft 32 is joined to a drive coupling 76 by conventional attachment. Drive cable 75 extends from drive coupling 76 and includes an outer sleeve 73 supporting a rotatable cable shaft 74.

FIG. 9 sets forth a front view of an alternate embodiment of the present invention dynamic mixer, generally referenced by numeral 140, utilizing a direct motor drive apparatus for rotational power replacing the rotational power provided through drive cable 75 in the above described embodiment. The alternate embodiment of the present invention shown in FIG. 9 is identical to the embodiments set forth above in FIGS. 1 through 8 apart from the differences arising out of replacing drive cable 75 with a direct motor drive apparatus. Accordingly, it will be understood that the structure and operation a dynamic mixer dispense valve 140 is in all respects, apart from the rotational power source, identical to dynamic mixer dispense valve 10 described above. Thus, the illustrations and operations set forth and described above for dynamic mixer dispense valve 10 will also be understood to apply with equal force and effect to dynamic mixer dispense valve 140

More specifically, dynamic mixer dispense valve 140 includes a generally “Y-shaped” valve manifold 11 having a pair of valve manifold portions 15 and 16 which extend upwardly and outwardly together with a downwardly extending cartridge manifold 17. Valve manifold portion 15 supports a valve assembly 40 which in turn supports a pneumatic valve actuator 12. Similarly valve manifold portion 16 supports a valve assembly 50 which in turn supports a pneumatic valve actuator 20. Valve manifold 11 further supports a pair of pneumatic mixer actuators 60 and 70 (pneumatic valve actuator 70 seen in FIG. 3) which in turn support and are operatively coupled to transversely extending elongated mixer actuator flange 80. Pneumatic mixer actuators 60 and 70 define respective actuator shafts 61 and 71 (shaft 71 seen in FIG. 3) which are received within apertures 81 and 82 defined in mixer actuator flange 80. A pneumatic control line 62 is coupled to pneumatic mixeractuator 60 while a pneumatic control line 72 is coupled to pneumatic mixer actuator 70 (seen in FIG. 3). A drive motor 150 is supported in combination with the remainder of dynamic mixer dispense valve 140 by conventional support means (not shown). Drive motor 150 includes an output shaft 151 coupled to a drive coupler 152 which is secured to mixer actuator flange 80 in a conventional attachment. A pair of pneumatic control lines 14 and 22 are coupled to pneumatic valve actuators 12 and 20 respectively. A supply of base component under pressure is coupled to valve assembly 50 by a base supply line 23. A supply of accelerator component is coupled to valve assembly 40 by an accelerator supply line 24. Cartridge manifold 17 further supports cartridge retainer 30 in a threaded attachment which is better seen in FIG. 7. Cartridge retainer 30 defines a cartridge discharge outlet 31.

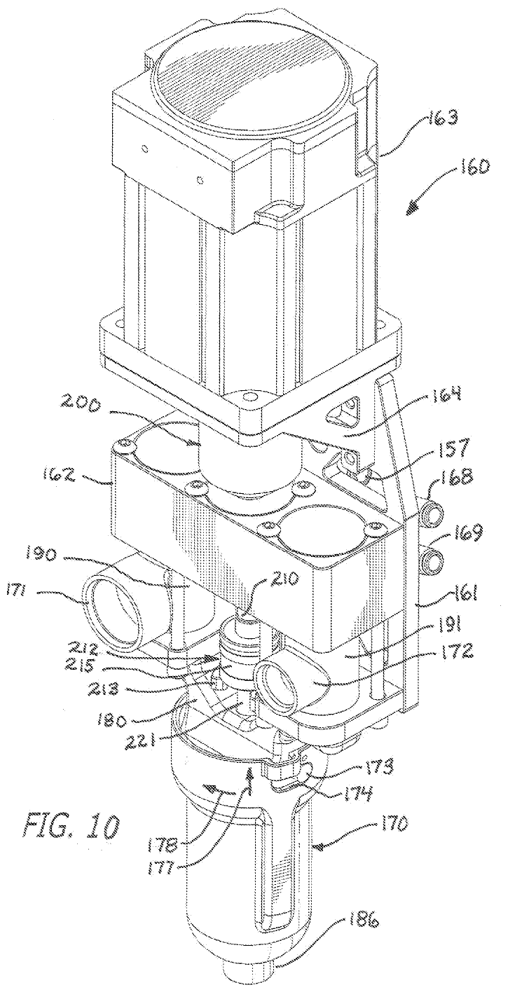

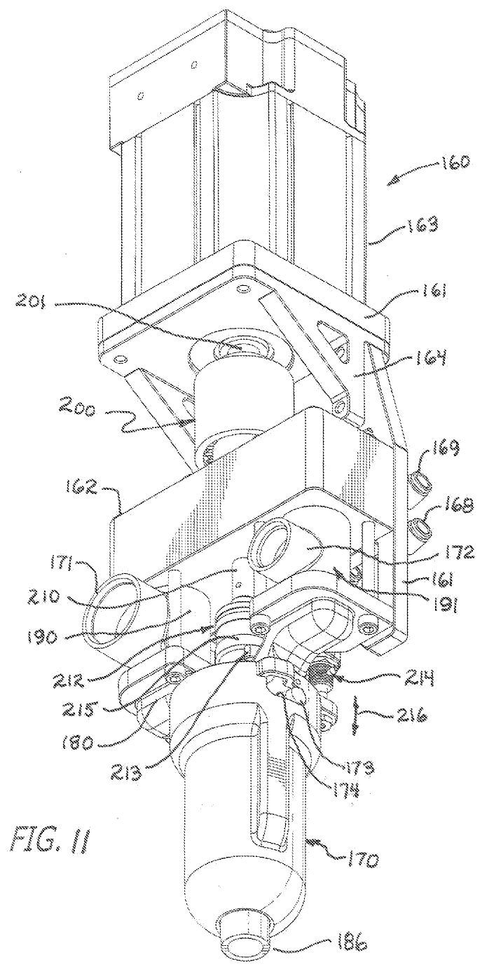

FIG. 10 sets forth a front perspective view of a still further alternate embodiment dynamic mixer dispense valve constructed in accordance with the present invention and generally referenced by numeral 160. By way of overview, dynamic mixer dispense valve 160 is similar to dynamic mixer dispense valve 140 set forth in FIG. 9 which utilizes a drive motor 150 in place of the drive cable shown in other embodiments to impart rotational motion to the mixer impeller. Dynamic mixer dispense valve 160 is further similar in that a base material and an accelerant are combined within a mixer cartridge and dispensed through a discharge outlet at the bottom of the assembly. Dynamic mixer dispense valve 160 further provides a significant advantage over the above-described embodiments of the invention in that the combined assembly of a mixer cartridge, a mixer impeller and extending mixer impeller driveshaft therefore is able to be installed and removed as a single snap-fit attached unit. This snap-fit installation facilitates the operation of dynamic mixer dispense valve 160 under robotic control.

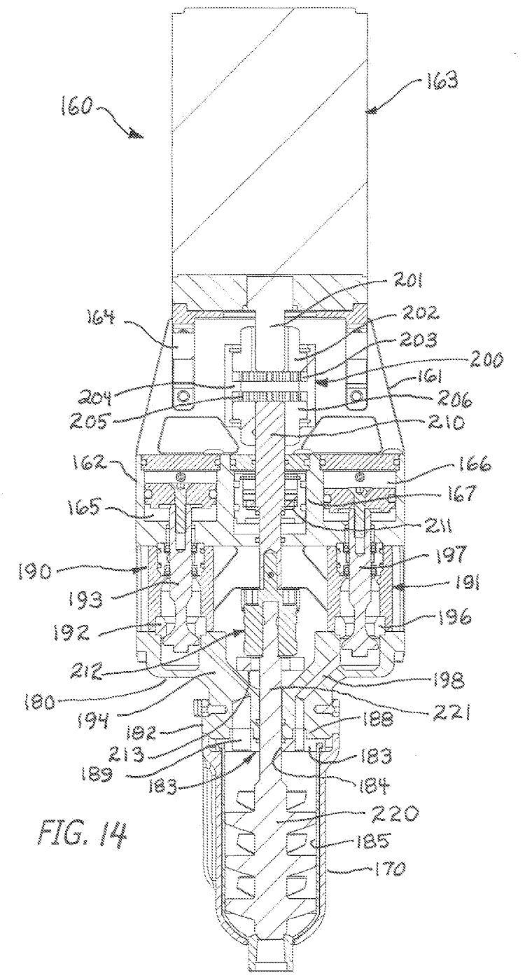

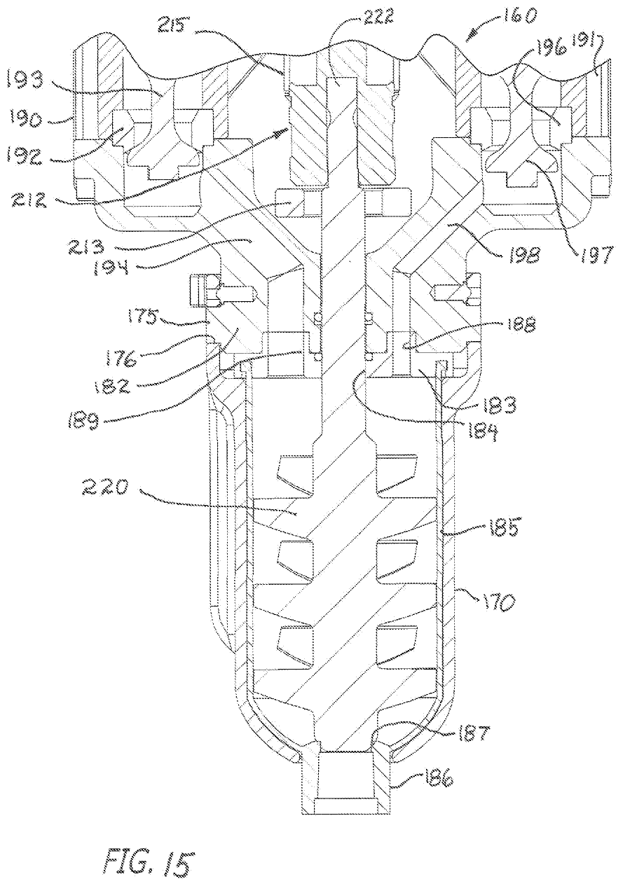

More specifically, dynamic mixer dispense valve 160 includes a mixer frame 161 supporting a motor support 164 at the upper end thereof and a manifold 180 at the lower end thereof. Mixer frame 161 further supports and actuator housing 162. Manifold 180 includes a pair of mounting posts 173 and 175 (post 175 seen in FIG. 15). Dynamic mixer dispense valve 160 includes a cartridge retainer 170 defining a pair of mounting slots 174 and 176 (slot 176 seen in FIG. 15). Cartridge retainer 170 further includes a discharge outlet 186 at the lower end thereof. Cartridge retainer 170 is received upon the lower surface of manifold 180 and is attached by initially moving cartridge retainer 170 upwardly in the direction indicated by arrow 177 until posts 173 and 175 are received within slots 174 and 176 respectively. Thereafter, cartridge retainer 170 is rotated in the direction indicated by arrow 178 to secure the attachment of cartridge retainer 170 to the underside of manifold 180. As is better seen below in FIG. 14, cartridge retainer 170 receives and supports a mixer cartridge 85 (seen in FIG. 15) having an upwardly extending mixer impeller shaft 221 extending therefrom. Mixer impeller shaft 221 extends upwardly through manifold 180 and is joined to a collet 212.

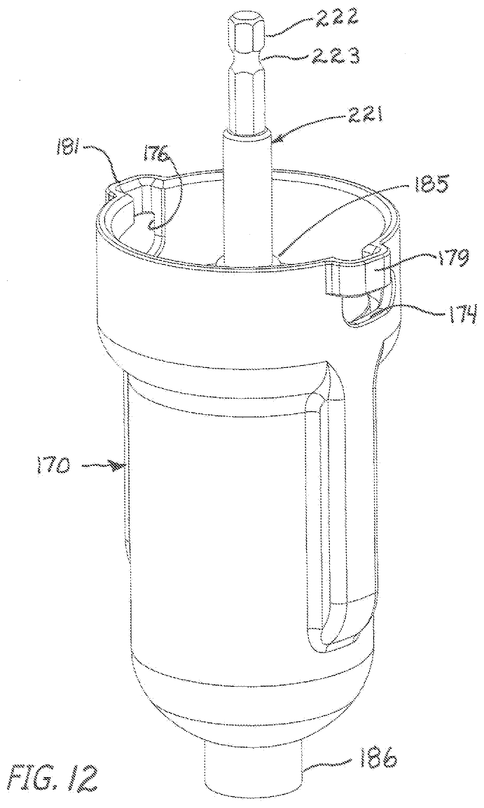

A drive motor 163 is supported upon motor support 164 such that a drive motor output shaft 201 (seen in FIG. 14) extends downwardly through motor support 164. A drive coupling 200 receives the lower end of output shaft 201 of drive motor 163. An intermediate shaft 210 extends downwardly from drive coupling 200 through actuator housing 162. A collet 212 is coupled to the lower end of intermediate shaft 210. As is set forth below in greater detail in FIG. 15, cartridge retainer 170 supports a mixer cartridge 185 within which a rotating mixer impeller 220 having an upwardly extending mixer impeller shaft 221 is supported. The upper end of mixer impeller shaft 221 is received within collet 212. Collet 212 is conventional in fabrication and includes a sliding collar 215 which is movable between a release position and a lock position. A fork 213 extends beneath sliding collar 215 and, as is better seen in FIG. 11, is operated by a pneumatic actuator 214 to lift sliding collar 215 between its release position and its lock position. In accordance with the conventional operation of collet 212, mixer impeller shaft 221 is releasably secured within collet 212 in a snap-fit attachment.

Manifold 180 supports a base material valve 190 and an accelerant material valve 191. Base material valve 190 includes a base supply input coupling 171 which in the anticipated use of dynamic mixer dispense valve 160 is coupled to a source of base material under pressure. Similarly in the anticipated use of dynamic mixer dispenser valve 160, accelerant supply input 172 is coupled to a supply of accelerant material under pressure. By means set forth below in greater detail base material valve 190 and accelerant material valve 191 are pneumatically controlled by actuators within actuator housing 162 two control the flow of their respective materials into the mixer cartridge supported within cartridge retainer 170. Toward this end, a pair of pneumatic lines 168 and 169 are provided for coupling operating air to base material valve 190 and accelerant material valve 191 race effectively.

As dynamic mixer dispense valve 160 is operated, base material and accelerant material are flowed into the mixer cartridge within cartridge retainer 170 under the control of base material valve 190 and accelerant material valve 191. As drive motor 163 produces rotational power at motor output shaft 201, drive coupling 200 is rotated. The rotation of drive coupling 200 in turn rotates intermediate shaft 210 thereby rotating collet 212. As collet 212 is caused to rotate, mixer impeller shaft 221 is rotated which, in turn, rotates mixer impeller 220 producing the desired mixing action of the flowing base and accelerant materials. By means described below in greater detail, a shaft actuator 167 (seen in FIG. 14) is pneumatically operated to lift mixer impeller 220 and allow the mixed material to flow outwardly through discharge outlet 186 of cartridge retainer 170. Conversely, shaft actuator 167 (seen in FIG. 14) is also operated to lower mixer impeller 220 downwardly to its closed position, thereby terminating the flow of material outwardly through discharge outlet 186.

In accordance with an important aspect of the present invention, and as is described below in greater detail, the removable attachment of cartridge retainer 170 and mixer cartridge 185 therein provided by moving collet 212 to its release position facilitates withdrawing mixer impeller shaft 221 from collet 212. This, in turn, allows mixer cartridge 185 and cartridge retainer 170 to be completely withdrawn from dynamic mixer dispense valve 160. In a further aspect of the present invention, this structure facilitates installing a cartridge retainer having a mixer cartridge therein by simply inserting the upper end of the mixer impeller shaft into collet 212 in a snap fit attachment.

FIG. 11 sets forth a further front perspective view of dynamic mixer dispense valve 160. As described above dynamic mixer dispense valve 160 includes a mixer frame 161 having a motor support 164 secured to the upper end thereof and having a manifold 180 secured to the lower end thereof. Mixer frame 161 further supports an actuator housing 162 which, as is better seen in FIG. 14, supports a pair of material valve actuators together with a shaft actuator. Dynamic mixer dispense valve 160 further includes a base material valve 190 and an accelerant material valve 191 both supported upon manifold 180. A base material input 171 and an accelerant material input 172 provide couplings for securing valves 190 and 191 respectively to supplies of base and accelerant material. Manifold 180 receives and supports cartridge retainer 170 in a “bayonet” type attachment. Thus, manifold 180 includes a pair of outwardly extending posts 173 and 175 (post 175 seen in FIG. 15). Cartridge retainer 170 defines a pair of cooperating slots 174 and 176 (slot 176 seen in FIG. 15). Accordingly, cartridge retainer 170 is removably securable to manifold 180 by aligning posts 173 and 175 with the corresponding slots defined in cartridge retainer 170 and thereafter moving cartridge retainer 170 upwardly toward manifold 180 while rotating cartridge retainer 170 locking the cartridge retainer in place.

Motor 163 rotates and output shaft 201 which in turn is coupled to a drive coupling 200. An intermediate shaft 210 is joined to the lower side of drive coupling 200 and extends downwardly through actuator housing 162. In the manner set forth below in FIG. 14, a mixer impeller 220 is supported within cartridge retainer 170 and includes a mixer impeller shaft 221 which extends outwardly through manifold 180 and is joined to the lower end of intermediate shaft 210 by a collet 212. Collet 212 is conventional in fabrication and includes a sliding collar 215 which is movable between a release position and a locking position under the urging of fork 213 supported beneath sliding collar 215. The rearward end of fork 213 is coupled to a pneumatic actuator 214. Actuator 214 facilitates moving fork 213 in the directions indicated by arrows 216 to lock and release collet 212. Thus, collet 212 will be understood to provide a snap-fit attachment coupling between mixer impeller shaft 221 and intermediate shaft 210 (both better seen in FIG. 14) which in turn facilitates the snap-fit insertion and withdrawal of cartridge retainer 170 and mixer impeller 220 therein.

FIG. 12 sets forth a perspective view of cartridge retainer 170 having a mixer cartridge 185 support therein. As described above, cartridge retainer 170 is generally cylindrical in shape and is sized to receive a conventional mixer cartridge 185. As is also described above, mixer cartridge 185 includes an upwardly extending mixer impeller shaft 221. Cartridge retainer 170 further defines a downwardly oriented discharge outlet 186 at the bottom of its cylindrical body. To facilitate the “bayonet” mounting apparatus utilized in the embodiment of the present invention set forth above, cartridge retainer 170 further defines a pair of generally “L-shaped” slots 174 and 176. Cartridge retainer 170 further includes a guide 179 extending across the upper portion of slot 174 and a similar guide 181 extending across the upper portion of slot 176. As described above in FIG. 11, manifold 180 supports a pair of outwardly extending generally cylindrical posts 173 and 175 which are received within slots 174 and 176 respectively during the attachment of cartridge retainer 170 to dynamic mixer dispense valve 160 in the manner set forth above in FIGS. 10 and 11.

In accordance with an important aspect of the present invention, mixer impeller shall 221 extents beyond the upper edge of cartridge retainer 170 when mixer cartridge 185 is situated within the interior of cartridge retainer 170. In further accordance with the present invention, mixer impeller shaft 221 defines a faceted end 222 and an encircling groove 223. Faceted end 222 and groove 223 are constructed in accordance with conventional fabrication techniques to facilitate the snap-fit insertion and coupling of faceted end 222 within collet 212 (seen in FIG. 11). It will be apparent to those skilled in the art that the essential feature of the cooperation between collet 212 and faceted end 222 of mixer impeller shaft 221 is the provision of a snap-fit insertion and lock for operation together with a “quick release” function suitable for removing faceted end 222 from collet 212. Thus, it will be equally apparent to those skilled in the art that other types of snap-fit type couplings providing this functional capability may be utilized in place of collet 212 and faceted end 222 without departing from the spirit and scope of the present invention.

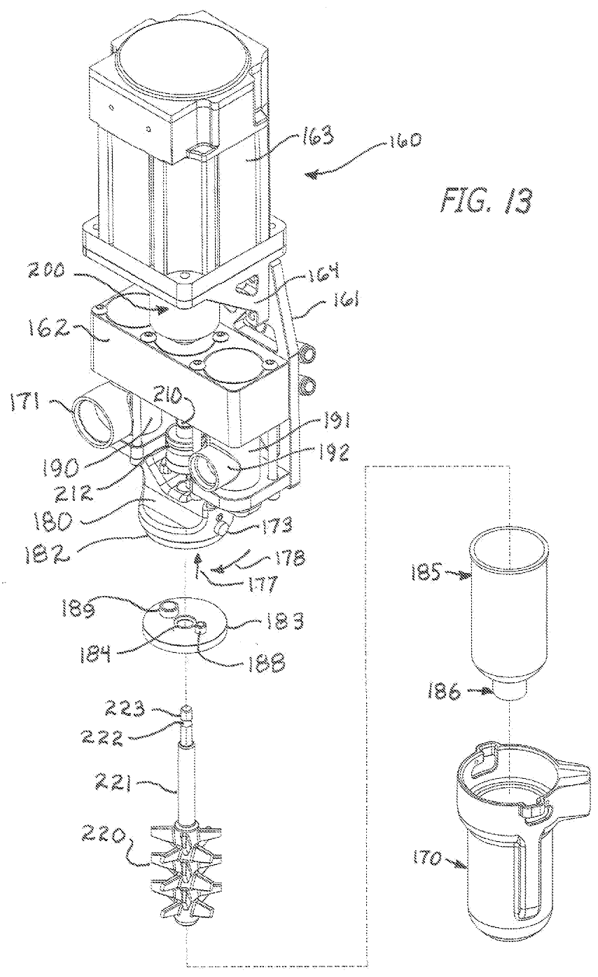

FIG. 13 sets forth a perspective assembly view of cartridge retainer 170 and mixer cartridge 185 prior to installation within dynamic mixer dispense valve 160. It will be recalled that dynamic mixer dispense valve 160 provides a significant advantage over the above-described embodiments of the invention in that the combined assembly of a mixer cartridge, a mixer impeller and extending mixer impeller drive shaft therefore is able to be installed and removed as a single snap-fit attached unit. It will also be recalled that this snap-fit installation and removal facilitates the operation of dynamic mixer dispense valve 160 under robotic control.

As described above, dynamic mixer dispense valve 160 includes a mixer frame 161 supporting a motor support 164 at the upper end thereof and a manifold 180 at the lower end thereof. Mixer frame 161 further supports and actuator housing 162. Manifold 180 includes a cartridge mating platform 182 and a pair of mounting posts 173 and 175 (post 175 seen in FIG. 15). A drive motor 163 is supported upon motor support 164 such that a drive motor output shaft 201 (seen in FIG. 14) extends downwardly through motor support 164. A drive coupling 200 receives the lower end of output shaft 201 of drive motor 163. An intermediate shaft 210 extends downwardly from drive coupling 200 through actuator housing 162. A collet 212 is coupled to the lower end of intermediate shaft 210. Collet 212 is conventional in fabrication and includes a sliding collar 215 which is movable between a release position and a lock position. A fork 213 extends beneath sliding collar 215 and, as is better seen in FIG. 11, is operated by a pneumatic actuator 214 to lift sliding collar 215 between its release position and its lock position. In accordance with the conventional operation of collet 212, mixer impeller shaft 221 is releasably secured within collet 212 in a snap-fit attachment.

Manifold 180 supports a base material valve 190 and an accelerant material valve 191. Base material valve 190 includes a base supply input coupling 171 which in the anticipated use of dynamic mixer dispense valve 160 is coupled to a source of base material under pressure. Similarly in the anticipated use of dynamic mixer dispenser valve 160, accelerant supply input 172 is coupled to a supply of accelerant material under pressure. By means set forth below in greater detail base material valve 190 and accelerant material valve 191 are pneumatically controlled by actuators within actuator housing 162 two control the flow of their respective materials into the mixer cartridge supported within cartridge retainer 170. Toward this end, a pair of pneumatic lines 168 and 169 are provided for coupling operating air.

As described above, dynamic mixer dispense valve 160 includes a cartridge retainer 170 defining a pair of mounting slots 174 and 176 (slot 176 seen in FIG. 15). Cartridge retainer 170 is received upon the lower surface of manifold 180 and is attached by initially moving cartridge retainer 170 upwardly in the direction indicated by arrow 177 until posts 173 and 175 are received within slots 174 and 176 respectively. Thereafter, cartridge retainer 170 is rotated in the direction indicated by arrow 178 to secure the attachment of cartridge retainer 170 to the underside of manifold 180. As is better seen below in FIG. 14, cartridge retainer 170 receives and supports a mixer cartridge 85 (seen in FIG. 15) which further includes a discharge outlet 186 at the lower end thereof. A mixer impeller having an upwardly extending mixer impeller shaft 221 extending therefrom. Mixer impeller shaft 221 extends beyond cartridge retainer 170 upwardly through manifold 180 and is joined to a collet 212.

In accordance with an important aspect of the present invention, and as is described below in greater detail, the removable attachment of cartridge retainer 170 and mixer cartridge 185 therein provided by moving collet 212 to its release position facilitates withdrawing mixer impeller shaft 221 from collet 212. This, in turn, allows mixer cartridge 185 and cartridge retainer 170 to be completely withdrawn from dynamic mixer dispense valve 160. In a further aspect of the present invention, this structure facilitates installing a cartridge retainer having a mixer cartridge therein by simply inserting the upper end of the mixer impeller shaft into collet 212 in a snap fit attachment.

Mixer cartridge 185 having a downwardly extending discharge outlet 186 receives mixer impeller 220 within its interior such that mixer impeller shaft 21 extends outwardly beyond the upper edge of mixer cartridge 185. Mixer impeller shaft 221 includes a faceted end 222 having a groove 223 formed theirin. As described above, faceted and 222 and groove 223 are fabricated to be received within collet 212 in a snap-fit attachment. With mixer impeller 220 received within mixer cartridge 185, a cartridge cap 183 is snap-fit upon the upper rim of cartridge 185. Cartridge cap 183 defines an aperture 184 through which mixer impeller shaft 221 extends together with a base material fitting 189 and an accelerant material fitting 188. Fittings 188 and 189 cooperate with cartridge mating platform 182 to establish flow paths between manifold 180 and the interior of mixer cartridge 185.

The fabrication of the present invention facilitates alternative sequences of assembly. In the first sequence, cartridge 185 receives mixer impeller 220 after which cartridge cap 183 is snap-fit to provide a cartridge sub assembly which is then placed within the interior of cartridge retainer 170. The combined assembly is then secured to the remainder of dynamic mixer dispense valve 160 by the above described bayonet fit attachment of cartridge retainer 170 in which cartridge retainer 170 is moved upwardly in the direction indicated by arrow 177 and then turned in the direction indicated by arrow 178. Alternatively, mixer cartridge 185, mixer impeller 220 and cartridge cap 183 may be preassembled and inserted into the remainder of dynamic mixer dispense valve 160 by simply forcing mixer impeller shaft 221 upwardly through cartridge mating platform 182 such that faceted end 222 is received within collet 212. Once the sliding collar on collet 212 is moved to its lock position, it captivates faceted end 222 of mixer impeller shaft 221 and holds the cartridge subassembly in place. Thereafter, cartridge retainer 170 is positioned upon mixer cartridge 185 and secured in the above described upward motion followed by rotational motion to secure the bayonet fit attachment of cartridge retainer 170. It will be apparent to those skilled in the art that either assembly is readily carried forward by automatic robotic apparatus.

FIG. 14 sets forth a section view of dynamic mixer dispense valve 160. As described above, dynamic mixer dispense valve 160 includes a mixer frame 161 having a motor support 164 at the upper end thereof and a manifold 180 at the lower end thereof. An actuator housing 162 is supported upon the front face of mixer frame 161. A drive motor 163 is supported upon motor support 164 by conventional fabrication techniques (not shown) and includes a downwardly extending output shaft 201.

Actuator housing 162 supports a pair of valve actuators 165 and 166 together with a shaft actuator 167. Valve actuators 165 and 166 are operative upon base material valve 190 and accelerant material valve 191 respectively while shaft actuator 167 is operative within the motor drive apparatus scribe below. Suffice it to note here that shaft actuator 167 is operative to raise and lower mixer impeller 220 within mixer impeller cartridge 185. This action is provided to implement the above described positive opening and closing of material discharge from cartridge 185.

More specifically, output shaft 201 is coupled to one end of a drive coupling 200 utilizing a gear 202. Drive coupling 200 defines a center rib 204 and a plurality of splines 203 above rib 204 and a plurality of splines 205 beneath rib 204. A gear 202 is coupled to output shaft 201 and engages splines 203. A gear 206 engages splines 205 and is coupled to the upper end of an intermediate shaft 210. Intermediate shaft 210 extends downwardly engaging shaft actuator 167 and is further coupled to collet 212. Collet 212, in turn, is coupled to mixer impeller shaft 221. A fork 213 is positioned beneath collet 212 and is operative in response to a pneumatic actuator 214 (seen in FIG. 11) in the manner described below to move collet 212 between a locking position and a release position. Collet 212 may be constructed in accordance with conventional fabrication techniques to provide a snap-fit attachment and quick release of the upper end of mixer impeller shaft 221.

Dynamic mixer dispense valve 160 includes a base material valve 190 having a valve seat 192 at the lower end thereof. Base material valve 190 further includes a valve stem 193 which is coupled to valve actuator 16 the five and is movable between an open and close position in response to valve actuator 165. Manifold 180 defines a material passage 194 extending from valve seat 192 downwardly through cartridge mating platform 182. Similarly, dynamic mixer dispense valve 160 includes an accelerant material valve 191 which includes a valve seat 196 and a valve stem 197. Valve stem 197 is moved by valve actuator 166 between an open and close position against valve seat 196. A passage 190 a is defined within manifold 180 and extends downwardly through cartridge mating platform 182. A cartridge retainer is secured to manifold 180 utilizing the above described bayonet type attachment. Within cartridge retainer 170 a mixer cartridge 185 is supported. Mixer cartridge 185 includes a downwardly extending discharge outlet 186 which passes through an aperture in the lower end of cartridge retainer 170. Mixer cartridge 185 further includes a cartridge 183 which in turn defines a center aperture 184 and a pair of fittings 188 and 189. In the assembled position shown, cartridge 183 is snap fitted upon the upper rim of mixer cartridge 185 such that when cartridge 185 is assembled to the remainder of dynamic mixer dispense valve 160 mixer impeller shaft 221 of mixer impeller 20 extends upward aperture 184 of cartridge 183 and is engaged and locked within collet 12. Additionally the assembly of mixer cartridge 185 two cartridge mating platform 182 brings fittings 188 and 189 into alignment with passages 198 and 194 respectively.

In operation, as dynamic mixer dispense valve 160 is operated, base material and accelerant material are flowed into mixer cartridge 185 under the control of base material valve 190 and accelerant material valve 191. Concurrently, as drive motor 163 produces rotational power at motor output shaft 201, drive coupling 200 is rotated. The rotation of drive coupling 200, in turn, rotates intermediate shaft 210 thereby rotating collet 212. As collet 212 is caused to rotate, mixer impeller shaft 221 is rotated which, in turn, rotates mixer impeller 220 producing the desired mixing action of the flowing base and accelerant materials. Shaft actuator 167 is pneumatically operated to lift intermediate shaft 210, collet 212, mixer impeller shaft 221 and mixer impeller 220 to allow the mixed material to flow outwardly through discharge outlet 186 of mixer cartridge 185. Conversely, shaft actuator 167 is also operated to lower mixer impeller 220 downwardly to its closed position thereby terminating the flow of material outwardly through discharge outlet 186.

FIG. 15 sets forth an enlarged section view of the lower portion of dynamic mixer dispense valve 160. As described above, dynamic mixer dispense valve 160 includes a manifold 180 having a pair of outwardly extending posts 173 and 175 together with a cartridge mating platform 182. Dynamic mixer dispense valve 160 further includes a pair of pneumatically actuated valves 190 and 191 having valve stems 193 and 197 respectively. Valves 190 and 191 further include valve seats 192 and 196. A passage 194 extends downwardly from valve 190 through cartridge mating platform 182. Similarly, a passage 198 extends downwardly from valve 191 through cartridge mating platform 182.

A cartridge retainer 170 includes a pair of bayonet mounting slots 176 and 174. Cartridge retainer 170 is removably attachable to manifold 180 by the above described upward insertion and twist action which utilizes posts 175 and 173 in cooperation with bayonet slots 176 and 174. Cartridge retainer 170 further receives mixer cartridge 185. Mixer cartridge 185 supports a snap-fit cartridge cap 183. Cartridge cap 183 defines an aperture 184 together with a pair of fittings 189 and 188. With cartridge 183 snap-fit assembled to the upper edge of mixer cartridge 185, aperture 184 is generally centered and fittings 189 and 188 are in alignment with the bottom portions of passages 198 and 194 respectively. A mixer impeller 220 is supported within the interior of mixer cartridge 185 such that mixer impeller shaft 221 extends outwardly through aperture 184 of cartridge cap 183. The upper end of mixer impeller shaft 221 defines a faceted end 222 which is received within collet 212. The latter is movable between locking and release positions by fork 213.

In accordance with an important advantage of the present invention, mixer cartridge 185 having mixer impeller 220 assembled therein and having cartridge cap 183 snap-fit to the upper edge thereof is able to be snap-fit assembled to dynamic mixer dispense valve 160 by simply positioning mixer cartridge 185 beneath manifold 180 and sliding mixer impeller shaft 221 upwardly to insert faceted end 222 into collet 212. This operation is carried forward with fork 213 having been actuated to position collet 212 in its open configuration. Once faceted end 222 is received within collet 212, the position of fork 213 is released and collet 212 assumes it's locking position in which faceted end 222 is captivated and engaged. Conversely, an assembled mixer cartridge is removable from dynamic mixer dispense valve 160 by actuating fork 213 to move collet 212 to is open or unlocked configuration thereby allowing mixer impeller shaft 221 and mixer cartridge 185 to be withdrawn.

As mentioned above, the present invention mixer cartridge may be assembled in either of two sequences of assembly. In both the first and second sequences, mixer impeller 220 is assembled within mixer cartridge 185 and thereafter cartridge cap 183 is snap-fit assembled to mixer cartridge 185 such that mixer impeller shaft 221 extends upwardly through aperture 184. With mixer impeller 220, mixer cartridge 185 and cartridge cap 183 sub-assembled, the combination may be assembled to dynamic mixer dispense valve 160 by inserting mixer impeller shaft 221 upwardly into collet 212 and releasing fork 213 following which cartridge retainer 170 is assembled over mixer cartridge 185 and secured. Alternatively, the subassembly provided by mixer cartridge 185, mixer impeller 220 and cartridge cap 183 may be initially positioned within cartridge retainer 170 and the combination of the subassembly and cartridge retainer 170 may then be installed as a single unit.

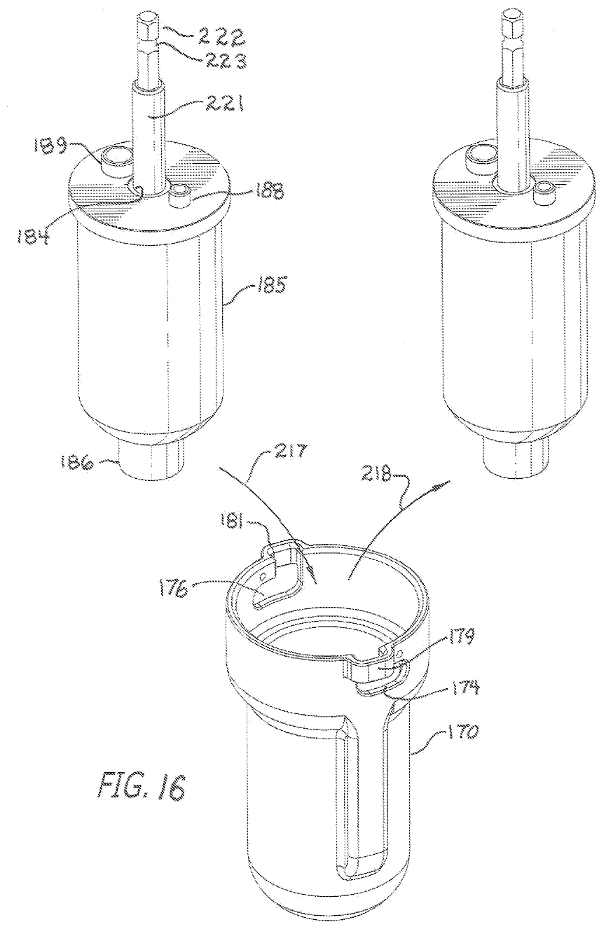

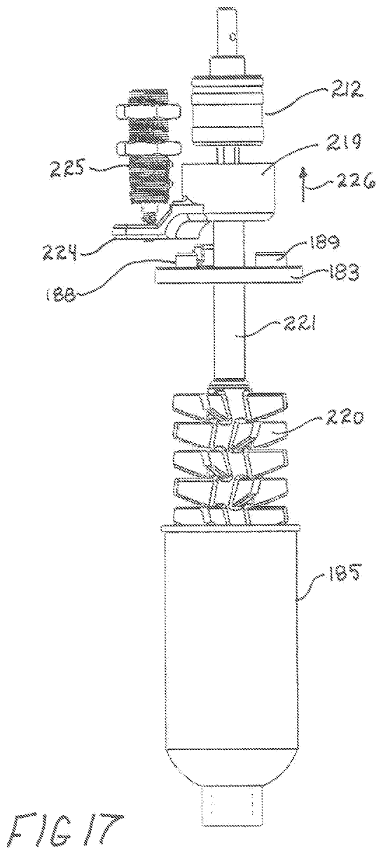

FIG. 16 sets forth an assembly view showing mixer cartridge 185 assembled to and removed from cartridge retainer 170. As described above, cartridge retainer 170 defines a pair of mounting slots 174 and 176 together with guides 179 and 181. As is also described above, cartridge retainer 170 is sized and configured to receive a conventional mixer cartridge. Accordingly, mixer cartridge 185 having a downwardly extending discharge outlet 186 supports a cartridge cap 183 in a snap-fit attachment. Cartridge cap 183 defines a center aperture 184 together with fittings 188 and 189. Cartridge 185 supports a mixer impeller 220 (seen in FIG. 13) such that mixer impeller shaft 221 of mixer impeller 220 extends upwardly through aperture 184 of cartridge cap 183. FIG. 16 serves to indicate the manner in which the subassembly of mixer cartridge 185, cartridge cap 183 and mixer impeller 220 may be inserted into cartridge retainer 170 as shown by arrow 217. Additionally FIG. 16 also shows the withdrawl of mixer cartridge 185 from cartridge retainer 170 as indicated by arrow 218.

FIG. 17 sets forth an assembly view of the operative elements which facilitate the present invention snap-fit installation and removal of a mixer cartridge from dynamic mixer dispense valve 160. Mixer cartridge 185 receives mixer impeller 220 such that mixer impeller shaft 221 extends upwardly from mixer cartridge 185. Cartridge cap 183 having fittings 188 and 189 is assembled upon the upper edge of mixer cartridge 185 in a nap-it attachment. The upper end of mixer impeller shaft 221 extends through an aperture in cartridge cap 183 and is received within collet 212. A sliding collar 219 is operated by a pneumatic actuator 225. Pneumatic actuator 225 is supported upon mixer frame 161 (shown in FIG. 11) and is coupled to sliding collar 219 by a flange 224. As actuator 225 operates, it moves sliding collar 219 upon collet 212 to alternatively lock or release mixer impeller shaft 221 thereby facilitating the snap-fit installation and removal of mixer cartridge 185.

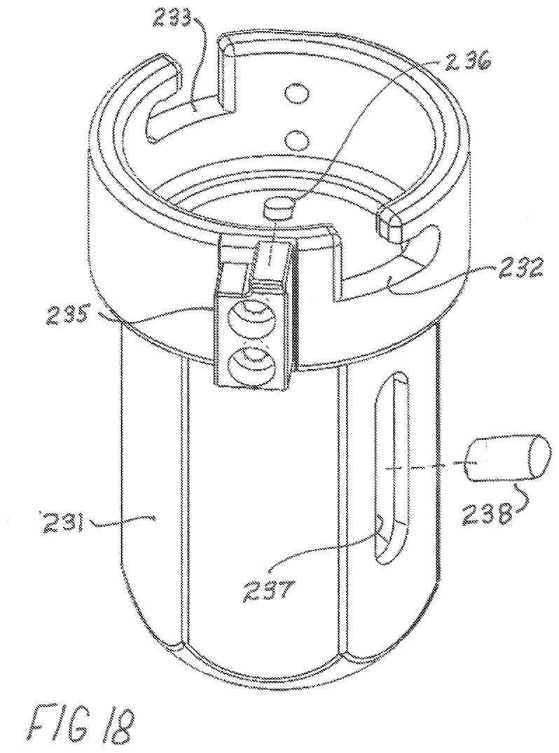

FIG. 18 sets forth a perspective view of a cartridge retainer in accordance with an alternate embodiment of the present invention generally reference by 230. Cartridge retainer 230 defines a generally cylindrical body having a plurality of external facets 231 which are believed to cooperate more effectively with robotic handling apparatus. Cartridge retainer 230 defines bayonet mount slots 232 and 233 which function in the same manner as the above described bayonet mount to facilitate securing cartridge retainer 230 to dynamic mixer dispense valve 160 (seen in FIG. 10). In accordance with a further advantage of the embodiment found in cartridge retainer 230, a magnetic housing 235 supporting a magnetic element is secured to the upper side wall of cartridge retains 230. A cooperating magnetics sensor 236 is supported at a convenient position (not shown) upon dynamic mixer dispense valve 160 such that magnetic sensor 236 responds to the presence and proximity of magnetic housing 235. In this manner, magnetic sensor 236 is able to provide a signal which confirms the proper positioning and assembly of cartridge retainer 230. In addition, an elongated aperture 237 is formed in a selected one of facets 231. A cartridge sensor 238 which may, for example, be an optical sensor, is supported upon dynamic mixer dispense valve 160 (seen in FIG. 10) at a convenient location in alignment with aperture 237. The operation of cartridge sensor 238 and aperture 237 provides sensing apparatus which is able to determine whether a mixer cartridge is inserted within the interior of cartridge retainer 230. Once again, it will be apparent to those skilled in the art that the placement and support of cartridge sensor 238 is carried forward in accordance with conventional fabrication techniques.

What has been shown is an improved and more effective dynamic mixer dispense valve suitable for use in mixing and applying high viscosity, disparate viscosity, high ratio, and/or relatively immiscible two part compounds that exhibit short cure times. The improved and effective dynamic mixer dispense valve shown facilitates use in a robotic environment and is suitable for flexibility of application duration so as to facilitate both short shot and long path deposition of such two component sealant and adhesive compounds while avoiding problems of unreliable interruption or termination of compound flow between shot cycles such as oozing or dripping.

While particular embodiments of the invention have been shown and described, it will be obvious to those skilled in the art that changes and modifications may be made without departing from the invention in its broader aspects. Therefore the aim in the appended claims is to cover all such changes and modifications as fall within the true spirit and scope of the invention.

That which is claimed is:

1. A dynamic mixer dispense valve for use in combination with metered supplies of a base component and an accelerator component to provide on demand dynamic mixing and dispensing of a mixed compound formed of the base component and accelerator component, said dynamic mixer dispense valve comprising:
a valve manifold having first and second valve manifold portions defining respective first and second valve manifold passages;
first and second valve assemblies having first and second material inputs for receiving supplies of base component and accelerator component respectively each operating in an open configuration allowing base component and accelerator component to flow into said first and second valve manifold passages respectively or a closed configuration in which flow of base component and accelerator component is prevented;
first and second pneumatic valve actuators coupled to said first and second valve assemblies respectively each operating in response to a pneumatic input to configure said first and second valve assemblies into either said open configuration or said closed configuration;
a cartridge manifold joined to said valve manifold and defining first and second cartridge manifold passages communicating with said first and second valve manifold passages;
a cartridge retainer joined to said cartridge manifold defining a cartridge retainer interior and a cartridge discharge outlet;
a cartridge coupled to said cartridge manifold and supported within said cartridge retainer interior defining an interior mixing chamber and a valve seatin communication with said cartridge discharge outlet;
a mixer impeller defining a plurality of mixer blades and a valve cone;
an impeller drive apparatus having a rotational power coupling and an impeller drive shaft, said impeller driveshaft being rotationally supported by said valve manifold and being operatively coupled to said mixer impeller to rotate said mixer impeller within said interior mixing chamber; and
a pneumatic mixer actuating apparatus coupled to said impeller driveshaft operating in response to a pneumatic input to move said mixer impeller to either a closed position in which said valve cone is seated within said valve seat to proven material flow through said cartridge discharge outlet or to move said mixer impeller to an open position in which said valve cone is spaced from said valve seat allowing material flow through said discharge outlet.
